(19) United States
(12) Patent Application Publication
(10) Pub. No.: US 2026/0135680 A1
(43) Pub. Date: May 14, 2026

(54) SBFD-BASED MEASUREMENT CONFIGURATION

(71) Applicant: InterDigital Patent Holdings, Inc., Wilmington, DE (US)

(72) Inventors: Jonghyun PARK, Syosset, NY (US); Moon IL LEE, Melville, NY (US); Aata EL HAMSS, Laval (CA); Nazli KHAN BEIGI, Longueuil (CA); Virgile GARCIA, Antibes (FR)

(73) Assignee: InterDigital Patent Holdings, Inc., Wilmington, DE (US)

(21) Appl. No.: 18/945,154

(22) Filed: Nov. 12, 2024

(51) Int. Cl. H04L 5/14; H04W 24/10; H04W 72/0446

(52) U.S. Cl. CPC H04L 5/14; H04W 24/10; H04W 72/0446

(57) ABSTRACT

In an aspect, a WTRU may receive a first duplexing configuration for a serving cell, including a first set of time resource configurations for each time resource in the first set of time resource configurations, the time resource configurations for each time resource include a duplexing direction, a frequency position, and a size of an uplink (UL) and/or a downlink (DL) sub-band. The WTRU may receive a cross link interference (CLI) measurement and reporting configuration including one or more CLI measurement resources and a respective CLI type for the serving cell. The WTRU receive a second duplexing configuration for a second cell. The WTRU may determine a CLI measurement resource for performing a CLI measurement, based on the determined CLI type and the respective CLI type included in the CLI measurement and reporting configuration, and perform the CLI measurement on the determined CLI measurement resource, and report the CLI measurement.

### BACKGROUND

Studies on 5G New Radio (NR) duplex operation are ongoing. This technology could be the great foundation in improving conventional time division duplex (TDD) operation by enhancing uplink (UL) coverage, improving capacity, reducing latency, and the like. Conventional TDD is based on splitting the time domain between the uplink and downlink. The feasibility of allowing full duplex, or more specifically, sub-band non-overlapping full duplex (SBFD) at the gNB within a conventional TDD band is investigated, where an UL sub-band may be configured within a DL slot/symbol. The realization of SBFD is contingent on resolving key challenges raised due to cross-link interference (CLI). The CLI can be measured at both the victim and/or aggressor User Equipment (UE)/Wireless Transmit/Receive Unit (WTRU). For WTRUs, the UL-to-DL CLI happens when an UL transmission from an aggressor WTRU causes interferences at a victim WTRUs receiving DL transmissions. WTRUs may also be subject to different types of UL-to-DL CLI.

Future 5G standard releases and 6G may introduce dynamic configuration of SBFD, for example, by allowing dynamic changes of configuration over time, configurations independent from each other in neighboring cells and/or UE/WTRU specific configurations, e.g., using flexible SBFD slots/symbols. Measurement resources, in particular CLI measurement resources, may be configured in a semi-static manner, typically using RRC signaling, and using absolute time indication for periodic resources. Since the SBFD configuration of the various neighboring and frequency adjacent cells may change dynamically, a semi-static CLI measurement/resource configuration may not capture the intended signals when the configurations are not aligned. Thus, the need exists for solutions that enable a WTRU to efficiently measure the CLI that may change from one measurement to another due to dynamic SBDF configuration changes.

### SUMMARY

In one general aspect, a method may include receiving a first duplexing configuration for a serving cell, the first duplexing configuration including a first set of time resource configurations for each time resource in the first set of time resource configurations, where the time resource configurations for each time resource in the first set of resource configurations includes a first duplexing direction, a first frequency position, and a size of a first uplink (UL) sub-band and/or a size of a first downlink (DL) sub-band for the serving cell. The method may also include receiving a cross link interference (CLI) measurement and reporting configuration including one or more CLI measurement resources and a respective CLI type for the serving cell. The method may furthermore include receiving a second duplexing configuration for a second cell, the second duplexing configuration including a second set of time resource configurations for each time resource, where the time resource configurations for each time resource in the second set of resource configurations includes a second duplexing direction, a second frequency position and a size of a second uplink (UL) sub-band and/or a size of a second downlink (DL) sub-band for cell for a second cell. The method may include determining a CLI type for the one or more CLI measurement resources based on the first duplexing configuration, the second duplexing configuration, or a combination of the first duplexing configuration and the second duplexing configuration. The method may include determining a CLI measurement resource for performing a CLI measurement based on the determined CLI type and a corresponding respective CLI type included in the CLI measurement and reporting configuration. Furthermore, the method may include performing the CLI measurement on the determined CLI measurement resource, and reporting the CLI measurement including at least one of: a CLI measurement result, the determined CLI measurement resource, the determined CLI type, the first duplexing configuration, the second duplexing configuration, or a combination of the first duplexing configuration and the second duplexing configuration. Other embodiments of this aspect include corresponding computer systems, apparatus, and computer programs recorded on one or more computer storage devices, each configured to perform the actions of the methods.

Implementations may include one or more of the following features. The method where each time resource corresponds to a slot, a symbol, or a combination of a slot and a symbol. Method where duplexing includes a sub-band full duplex (SBFD) operation mode, and where the first duplexing direction is a first SBFD pattern and the second duplexing direction is a second SBFD pattern. The method where the CLI type includes at least one of a co-channel CLI type, a SBFD leakage CLI type, or an inter-carrier CLI leakage type. The method where the second duplexing configuration for the second cell is received in a medium access control (MAC) message, a radio resource control (RRC) message, or a downlink control information (DCI) message and includes a second cell identity (cell ID). The method where determining the CLI type for measurement resource for performing CLI measurement further may include: determining there are no CLI measurement resources of the determined CLI type and a same respective CLI type included in the received CLI measurement and reporting configuration. The method where performing the CLI measurement on the determined CLI measurement resource is skipped in a case where there are no CLI measurement resources of the determined CLI type and a same respective CLI type included in the received CLI measurement and reporting configuration. The method may include sending an indication that the CLI measurement is skipped in the case where there are no CLI measurement resources of the determined CLI type and a same respective CLI type included in the received CLI measurement and reporting configuration, and reporting layer 3(L3 ) measurements. The method may include determining a CLI measurement resource for performing the CLI measurement based on priority rules in a case where it is determined there are more than one CLI measurement resource of the determined CLI resource type and a same respective CLI resource type. Implementations of the described techniques may include hardware, a method or process, or a computer tangible medium.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates examples of Cross Link Interference (CLI) including inter-gNB and inter-UE CLI;

FIG. 3 illustrates examples of different inter-sub-band and inter-carrier leakage CLI cases;

FIG. 4 illustrates an example of a SBFD configuration;

FIG. 5 illustrates an example of CLI type determination based on serving cell and neighboring (second) cell configuration;

FIG. 6 illustrates an example of CLI resource selection based on the serving cell SBFD pattern; and

FIG. 7 is a flowchart of an example process of a WTRU determining CLI measurement resources based on a second cell SBFD configuration.

### DETAILED DESCRIPTION

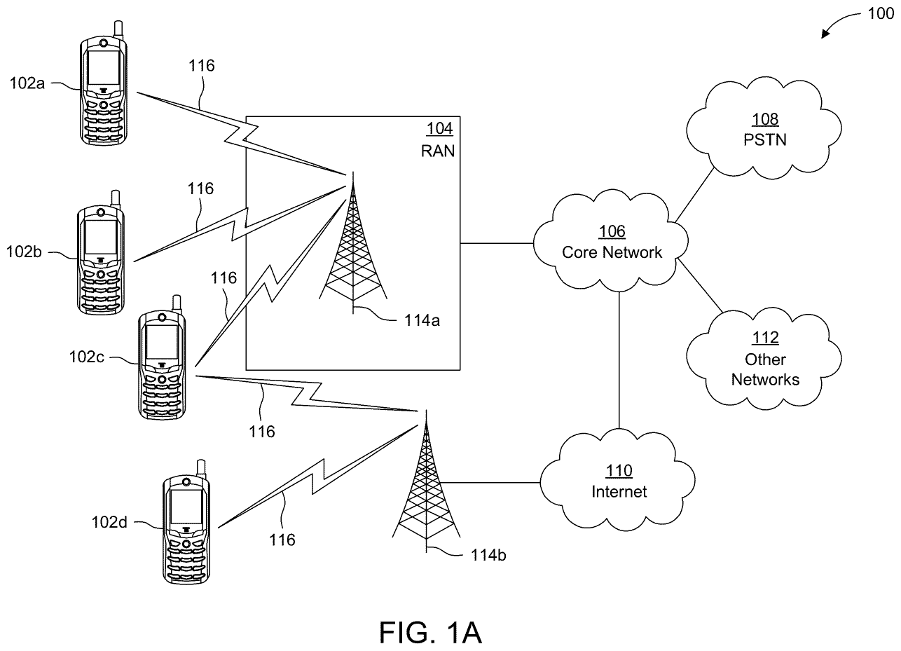

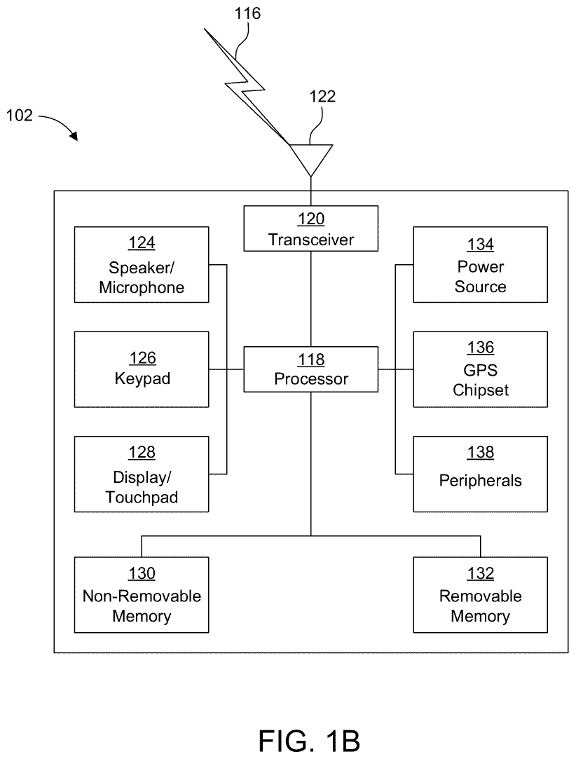

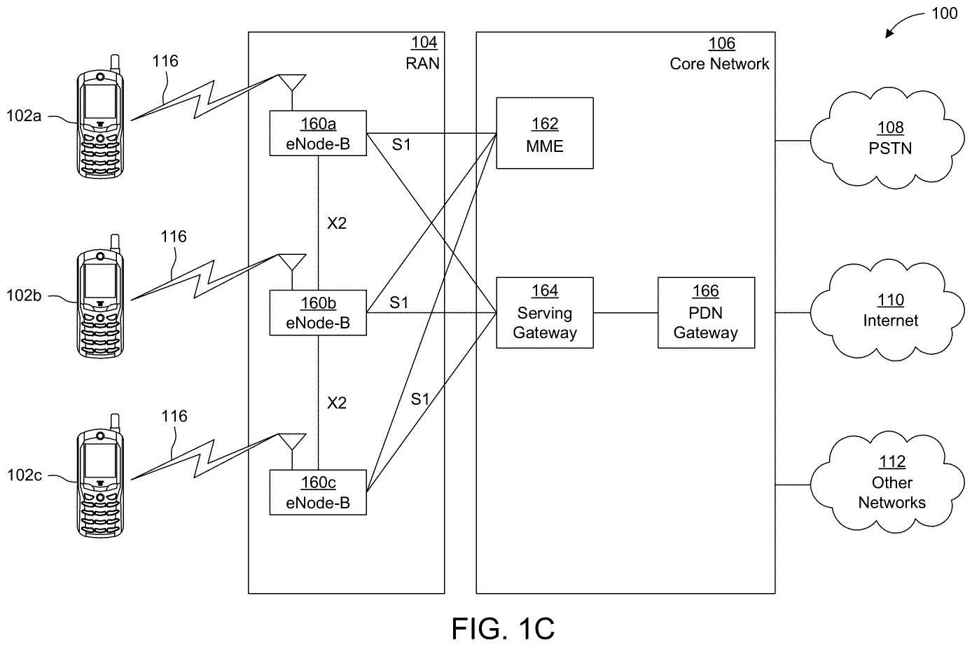

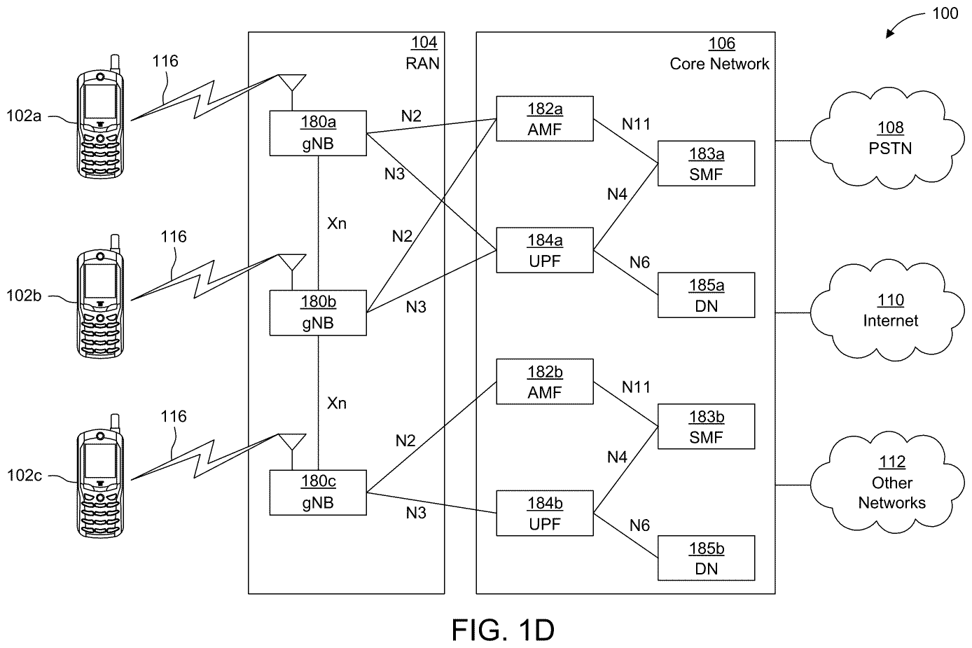

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180 a, 180 b, 180 c without also accessing other RANs (e.g., such as eNode-Bs 160a, 160b, 160c). In the standalone configuration, WTRUs 102a, 102 b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

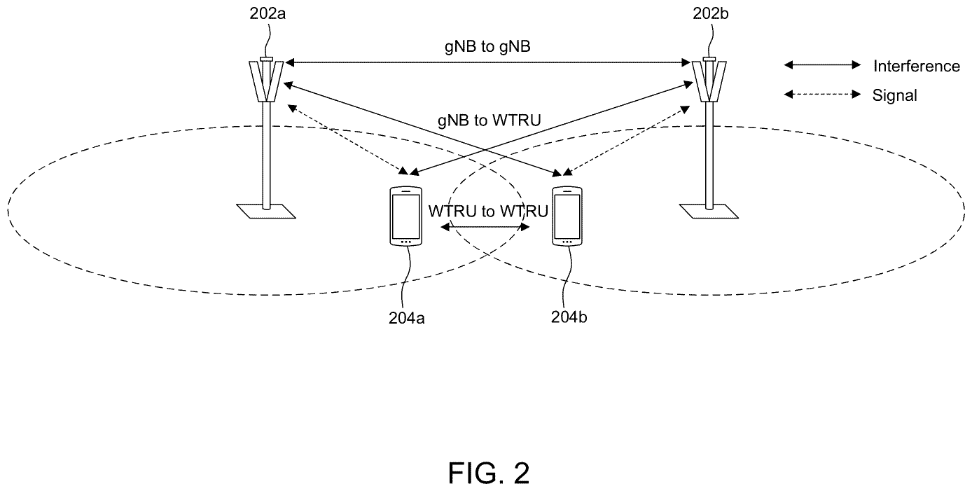

FIG. 2 illustrates examples of Cross Link Interference (CLI) including inter-gNB and inter-UE CLI.

In the example illustrated in FIG. 2, gNB 202a is actively serving WTRU 204a and gNB 202b is actively serving WTRU 202 b. The UL/DL communication between gNB 202a and WTRU 204 a may experience CLI due to signaling between gNB 202a and WTRU 204b, signaling between gNB 202b and WTRU 204a, and signaling between WTRU 204a and WTRU 204b. Likewise, the UL/DL communication between gNB 202b and WTRU 204b may experience from CLI due to signaling between gNB 202a and WTRU 204b, signaling between gNB 202b and WTRU 204a, and signaling between WTRU 204a and WTRU 204b. Each WTRU may be subject to different types of UL to DL CLI.

Intra-frequency, inter-cell (co-channel) CLI may occur when neighboring cells are configured with different link directions in the same carrier frequency, either for SBFD or dynamic/flexible TDD cases. Other types of CLI include Intra-frequency, inter-sub-band CLI and Inter-frequency CLI.

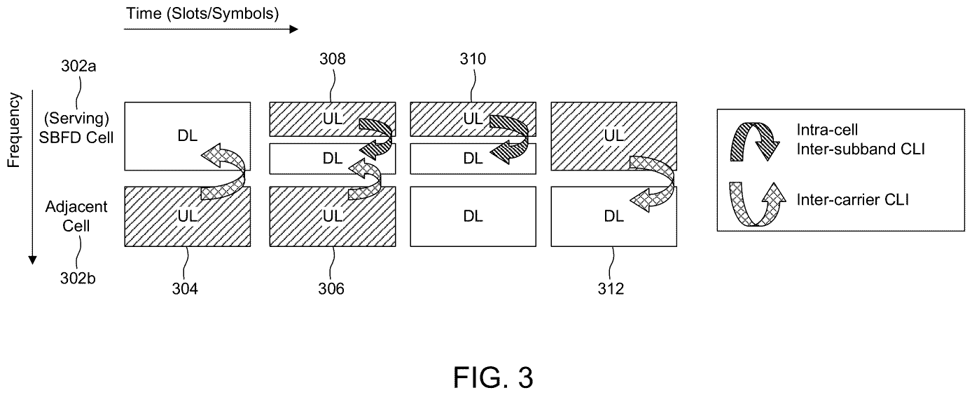

FIG. 3 illustrates examples of different inter-sub-band and inter-carrier leakage CLI cases. The example illustrated in FIG. 3 includes a serving cell 302a performing SBFD, and a second cell or adjacent cell 302b. Illustrated at 304 is an example of an inter-carrier CLI occurrence between a DL of serving cell 302a and an UL adjacent cell 302b. A similar occurrence of an inter-carrier CLI is illustrated at 306. An example of intra-cell CLI is illustrated at 308. This CLI occurrence is with respect to a SBFD of an UL and a DL of serving cell 302a. A similar occurrence of an intra-cell CLI is illustrated at 310. Also illustrated at 312 is an occurrence of inter-carrier CLI occurrence with an UL of serving cell 302a and a DL adjacent cell 302b.

In an example embodiment, a WTRU may select the CLI measurement resources from a configured pool of resources based on the (dynamic) SBFD configuration of its cell and of the neighboring cells so that the resources are aligned with potential CLI from other WTRUs. The WTRU may report measurements associated to a CLI resource based on the SBFD configurations from a serving cell and a second or neighbor cell and the resulting CLI type.

In an example embodiment, a WTRU may receive a (pre)configuration for a serving cell including: the duplexing/SBFD configuration for each time resource (slot and/or symbol) that includes the duplexing direction and/or SBFD pattern (e.g., DU, UD, DUD) and the frequency position and size of the UL and DL sub-bands; and a CLI measurement and reporting configuration, e.g., periodic (L1-)CLI-RSSI, including: one or more CLI measurement resources (time, frequency), e.g., as an ordered list, a CLI type, e.g., one of: SBFD leakage CLI, co-channel CLI, inter-carrier CLI leakage, and optionally another cell (e.g., cell ID).

The WTRU may receive an indication (e.g., via MAC or DCI) of the configuration of the duplexing direction and/or SBFD pattern of another cell (e.g., a neighboring cell using the cell ID) and determine a CLI type for the CLI measurement resources based on the duplexing/SBFD configuration of the serving cell and/or the other cell. This indication may be that a CLI measurement resource in the DL sub-band of a SBFD symbol in the serving cell is of type “SBFD leakage CLI,” that a CLI measurement resource in a DL (sub)band of the serving cell and corresponding to an UL (sub)band on the other (neighboring) cell is of type “co-channel CLI,” or that a CLI measurement resource in a DL (sub)band of the serving cell and frequency-adjacent to another cell/carrier configured in an UL is of type “inter-carrier CLI leakage”

The WTRU may determine the CLI measurement resource to perform the CLI measurement on based on the determined CLI type. For example, the WTRU may select, if any, the resources whose determined CLI type corresponds to a CLI type in the received CLI measurement and reporting configuration. If multiple resources satisfy the condition, The WTRU may select one resource based on priority rules (e.g., based on the ordered list). If none of resources satisfy the condition, the WTRU may skip the measurement.

The WTRU may perform the CLI measurement on the determined CLI measurement resource. The WTRU may then report the CLI measurement, including, e.g., the measurement result, the resource selected, the determined CLI type and/or corresponding SBFD configuration of the cells. If no resource is configured on time resources where CLI may be generated, the WTRU may skip the measurement. If the WTRU did not perform measurement, the WTRU may skip the report and may report the remaining measurements (e.g., when using L3 averaging) and indicate that the WTRU did not perform the measurement based on configuration.

As described in this example, the WTRU may avoid unnecessary measurement and reporting when no CLI is be expected from other UEs (reduced overhead and reduced energy consumption) and may improve CLI measurement accuracy, leading to better CLI handling and scheduling. This may be accomplished by measuring CLI when it happens and reporting real CLI values, and for filtered measurement, by measuring more consistent CLI over time.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) may be used herein to represent ‘and/or’, where for example, ‘A/B’ may imply ‘A and/or B’.

Hereinafter, the term “sub-band” is used to refer to a frequency-domain resource and may be characterized by at least one of the following: a set of resource blocks (RBs), set of resource block sets (RB sets), e.g. when a carrier has intra-cell guard bands, a set of interlaced resource blocks, a bandwidth part, or portion thereof, or a carrier, or portion thereof.

For example, a sub-band may be characterized by a starting RB and number of RBs for a set of contiguous RBs within a bandwidth part. A sub-band may also be defined by the value of a frequency-domain resource allocation field and bandwidth part index.

Hereinafter, the term “XDD” is used to refer to a sub-band-wise duplex (e.g., either UL or DL being used per sub-band) and may be characterized by at least one of the following: Cross Division Duplex (e.g., sub-band-wise FDD within a TDD band), sub-band-based full duplex (e.g., full duplex as both UL and DL are used/mixed on a symbol/slot, but either UL or DL being used per sub-band on the symbol/slot), frequency-domain multiplexing (FDM) of DL/UL transmissions within a TDD spectrum, a sub-band non-overlapping full duplex (SBFD) (e.g., non-overlapped sub-band full-duplex), a full duplex other than a same-frequency (e.g., spectrum sharing, sub-band-wise-overlapped) full duplex, or an advanced duplex method, e.g., other than (pure) TDD or FDD.

Hereinafter, the term “dynamic(/flexible) TDD” is used to refer to a TDD system/cell which may dynamically (and/or flexibly) change/adjust/switch a communication direction (e.g., a downlink, an uplink, or a sidelink, etc.) on a time instance (e.g., slot, symbol, subframe, and/or the like). In an example, a system employing dynamic/flexible TDD, a component carrier (CC) or a bandwidth part (BWP) may have one single type among ‘D’, ‘U’, and ‘F’ on a symbol/slot, based on an indication by a group-common(GC)-DCI (e.g., format 2_0) comprising a slot format indicator (SFI), and/or based on tdd-UL-DL-config-common/dedicated configurations. On a given time instance/slot/symbol, a first gNB (e.g., cell, TRP) employing dynamic/flexible TDD may transmit a downlink signal to a first WTRU being communicated/associated with the first gNB based on a first SFI and/or tdd-UL-DL-config configured/indicated by the first gNB, and a second gNB (e.g., cell, TRP) employing dynamic/flexible TDD may receive an uplink signal transmitted from a second WTRU being communicated/associated with the second gNB based on a second SFI and/or tdd-UL-DL-config configured/indicated by the second gNB. In an example, the first WTRU may determine that the reception of the downlink signal is being interfered by the uplink signal, where the interference caused by the uplink signal may refer to a UE-to-UE cross-layer interference (CLI).

Hereinafter, the term “SBFD” is used to refer to a sub-band-wise duplex (e.g., either UL or DL being used per sub-band) and may be characterized by at least one of the following: Cross Division Duplex (e.g., XDD, sub-band-wise FDD within a TDD band), sub-band-based full duplex (e.g., full duplex as both UL and DL are used/mixed on a symbol/slot, but either UL or DL being used per sub-band on the symbol/slot), frequency-domain multiplexing (FDM) of DL/UL transmissions within a TDD spectrum, a sub-band non-overlapping full duplex (SBFD) (e.g., non-overlapped sub-band full-duplex), a full duplex other than a same-frequency (e.g., spectrum sharing, sub-band-wise-overlapped) full duplex, an advanced duplex method, e.g., other than (pure) TDD or FDD, e.g., partial in-band full duplex, sub-band overlapping full duplex, in-band full duplex (IBFD).

In the following description, a property of a grant or assignment may consist of at least one of the following: a frequency allocation; an aspect of time allocation, such as a duration; a priority; a modulation and coding scheme; a transport block size; a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); or any parameter provided in a DCI, by MAC or by RRC for the scheduling the grant or assignment.

In the following description, an indication by DCI may consist of at least one of the following: an explicit indication by a DCI field or by RNTI used to mask CRC of the PDCCH, or an implicit indication by a property such as DCI format, DCI size, Coreset or search space, aggregation level, first resource element of the received DCI (e.g., index of first Control Channel Element), where the mapping between the property and the value may be signaled by RRC or MAC.

Hereafter, a signal may be interchangeably used with one or more of following: sounding reference signal (SRS); channel state information - reference signal (CSI-RS); demodulation reference signal (DM-RS); phase tracking reference signal (PT-RS); or a synchronization signal block (SSB).

Hereafter, a channel may be interchangeably used with one or more of following: physical downlink control channel (PDCCH); physical downlink shared channel (PDSCH); physical uplink control channel (PUCCH); physical uplink shared channel (PUSCH); and a physical random access channel (PRACH).

Hereafter, downlink reception may be used interchangeably with Rx occasion, PDCCH, PDSCH, and SSB. Hereafter, uplink transmission may be used interchangeably with Tx occasion, PUCCH, PUSCH, PRACH, SRS transmission. Hereafter, RS may be interchangeably used with one or more of RS resource, RS resource set, RS port and RS port group. Hereafter, RS may be interchangeably used with one or more of SSB, CSI-RS, SRS and DM-RS, but still.

Hereafter, time instance may be interchangeably used with slot, symbol, subframe, but still consistent with this invention. Hereafter, UL-only and DL-only Tx/Rx occasions may interchangeably be used with legacy TDD UL or legacy TDD DL, respectively, and still consistent with description. In an example, the legacy TDD UL/DL Tx/Rx occasions may be the cases where SBFD is not configured and/or where SBFD is disabled.

Hereafter, a UL signal (e.g., at least one of SRS, DMRS, PUSCH, PUCCH, PRACH, PTRS, etc.) may be used interchangeably with a UL signal or channel, or a UL channel or signal. Hereafter, a DL signal (e.g., at least one of CSI-RS, SSB, PDSCH, PDCCH, PBCH, PTRS, etc.) may be used interchangeably with a DL signal or channel, or a DL channel or signal.

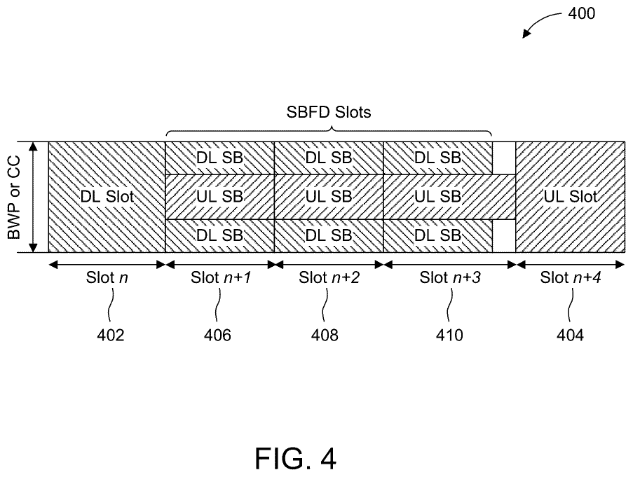

FIG. 4 illustrates an example of a SBFD configuration. A WTRU may be configured with one or more types of slots within a bandwidth, wherein a first type of slot may be used or determined for a first direction (e.g., downlink, or sidelink (e.g., UE-to-UE communication, device-to-device communication)); a second type of slot may be used or determined for a second direction (e.g., uplink, or sidelink); a third type of slot may have a first group of frequency resources within the bandwidth for a first direction and a second group of frequency resources within the bandwidth for a second direction. Herein, the bandwidth may be interchangeably used with bandwidth part (BWP), carrier, sub-band, and system bandwidth; the first type of slot (e.g., the slot for a first direction) may be referred to as downlink (and/or sidelink) slot; the second type of slot (e.g., slot for a second direction) may be referred to as uplink (and/or sidelink) slot; the third type of slot may be referred to as Sub-Band (non-overlapping or overlapping) Full Duplex (SBFD) slot, e.g., comprising at least one of DL SB(s), UL SB(s), sidelink SB(s), guard band(s) (or RB(s)), and flexible SB(s) (e.g., SB(s) that may be dynamically determined as one of DL SB(s), UL SB(s), sidelink SB(s)); the group of frequency resource for a first direction may be referred to as downlink (and/or sidelink) sub-band, downlink (and/or sidelink) frequency resource, or downlink (and/or sidelink) RBs; the group of frequency resource for a second direction may be referred to as uplink (and/or sidelink) sub-band, uplink (and/or sidelink) frequency resource, or uplink (and/or sidelink) RBs; the group of frequency resource for a flexible direction (e.g., that can be configured for a first direction, second direction, etc.) may be referred to as flexible sub-band, flexible frequency resource, or flexible RBs; and the group of frequency resource between a first direction and a second direction may be referred to as guard band, guard frequency resource, or guard RBs.

As illustrated in FIGS. 4, 402 is a first slot in the downlink direction, and slot 404 is a slot (n+4) in the UL direction. Slots 406-408 are SBFD slots. These slots include a first group of frequency resources within the bandwidth for a first direction and a second group of frequency resources within the bandwidth for a second direction. Slot n+1, 406, includes two groups of frequency resources in the DL direction and a group of frequency resources in a UL direction. Slot n+2, 408, and slot n+3, 410, also include two groups of frequency resources in the DL direction and a group of frequency resources in a UL direction.

In an example, a WTRU may be (pre)configured with one or multiple groups of frequency resources, where some groups of frequency resources are explicitly configured, and some are implicitly configured. For instance, the WTRU may be configured, e.g., within a cell or BWP, with a first group of frequency resources assigned to DL and a second group of resources assigned to UL as shown at 406-410 of FIG. 4. The WTRU may infer that the remaining group(s) of resources are used as guard band. Alternatively, the WTRU may receive a configuration including an UL sub-band and a guard band, and infer that the remaining resources are a DL sub-band, and so forth.

In an example, a SBFD-enabled WTRU may receive configuration information or be configured with one or more SBFD UL, DL, sidelink, flexible, and/or guard sub-bands in one or more DL/UL/flexible TDD time instances (e.g., symbols, slots, frames, and so forth). The WTRU may be configured with one or more resource allocations for SBFD sub-bands.

For example, the SBFD configuration may include a flag signal (e.g., enabled/disabled), where for example a first value (e.g., zero (0)) indicates a first mode of operation (e.g., SBFD configuration), and a second value (e.g., one (1)) may indicate a second mode of operation (e.g., non-SBFD operation). The modes of operation (e.g., SBFD and/or non-SBFD) may be indicated via MIB, SIB, RRC, MAC-CE, DCI, and so forth.

The WTRU may receive the time resources (e.g., one or more symbols, slots, and so forth), for which the first mode of operation (e.g., SBFD) is defined in for example one or more BWPs, sub-bands, component carriers (CC), cells, and so forth. The WTRU may receive the frequency resources (e.g., sub-bands/BWPs including one or more PRBs) within (active and/or linked) BWP, for which the first mode of operation (e.g., SBFD) is configured. The time instances (e.g., slots, symbols) may be indicated based on periodic, semi-persistent, or aperiodic type configurations. In an example, the time instances may be indicated via a bitmap configuration, where each bit corresponds to a time instance (e.g., slot, symbol, subframe, etc.) and each bit indication indicates whether corresponding time instance can be used for the first or second mode of operation.

In an example, a WTRU may be configured with a DL TDD configuration for a component carrier (CC) or a BWP for one or more Rx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured for the transmission in UL channels and/or Tx occasions.

In another example, the WTRU may be configured with an UL TDD configuration for a component carrier (CC) or a BWP for one or more Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured as the DL channels and/or Rx occasions.

In another example, the WTRU may be configured with a DL, UL, or Flexible TDD configuration for a component carrier (CC) or a BWP for one or more Rx/Tx occasions (e.g., via tdd-UL-DL-config-common, dedicated configurations, slot format indicator (SFI), and so forth). As such, if the first mode of operation (e.g., SBFD) is configured, one or more of the configured frequency resources (e.g., sub-bands, PRBs, and/or BWPs) may be configured for the first mode of operation (e.g., either UL transmission or DL reception based on the configurations).

The duplexing mode for the first mode of operation (e.g., SBFD configuration (UL/DL)) may be indicated via a flag indication, where for example a first value (e.g., zero (0)) may indicate a first direction (e.g., UL duplexing mode), and a second the value (e.g., one (1)) may indicate a second direction (e.g., DL duplexing model). The duplexing mode configuration and/or flag for the first mode of operation (e.g., SBFD) may be configured as part of modes of operation configuration, for example via MIB, SIB, RRC, DCI, MAC-CE, etc. The duplexing mode configuration and/or flag for the first mode of operation (e.g., SBFD) may be configured as part of resource allocation configuration for a Tx/Rx occasion.

In an example, a WTRU may be configured with one or more types of slots. The WTRU may be configured with a first slot with a first type, where the first type may, for example, be a SBFD slot. The WTRU may be configured with a second slot with a second type, where the second type may be for example non-SBFD slot. As for the first slot with the first type (SBFD), the WTRU may be configured with one or more DL, UL, flexible, guard, etc. sub-bands in the frequency domain, throughout the BWP, for the duration of the first slot. However, in the second slot with the second type (non-SBFD), the WTRU may be configured with only one direction type, for example DL, UL, flexible, etc., in the frequency domain, throughout the BWP, for the duration of the second slot.

In another example, if the WTRU is configured with a second slot with UL direction, this implies legacy TDD UL slot, UL-only slot, and/or non-SBFD UL slot. In another example, if the WTRU is configured with a third slot with second type (non-SBFD) with DL direction, this implies legacy TDD DL slot, DL-only slot, and/or non-SBFD DL slot. In another example, if the WTRU is configured with a fourth slot with second type (non-SBFD) with flexible direction, this implies legacy TDD flexible slot and/or non-SBFD flexible slot, and so forth.

In another example, the WTRU may be configured with a SBFD ‘DU’ configuration, referring to a configuration where the upper-frequency sub-band of the cell's carrier is configured as a DL sub-band, while the lower-frequency sub-band of the same cell's carrier is configured as an UL sub-band. One or more guard-band (i.e., unused frequency resources) may be configured at the edge of the cell's carrier or in between sub-bands.

In another example, the WTRU may be configured with a SBFD ‘UD’ configuration, referring to a configuration where the upper-frequency sub-band of the cell's carrier is configured as an Uplink sub-band, while the lower-frequency sub-band of the same cell's carrier is configured as a downlink sub-band. One or more guard-band (i.e., unused frequency resources) may be configured at the edge of the cell's carrier or in between sub-bands.

In another example, the WTRU may be configured with a SBFD ‘DUD’ configuration, referring to a configuration with three sub-bands and both the upper-frequency and lower-frequency sub-band of the cell's carrier is configured as Downlink sub-bands, while the middle-frequency sub-band of the same cell's carrier is configured as an uplink sub-band. One or more guard-band (i.e., unused frequency resources) may be configured at the edge of the cell's carrier or in between sub-bands.

In another example, the WTRU may be configured with a SBFD ‘UDU’ configuration, referring to a configuration with three sub-bands and both the upper-frequency and lower-frequency sub-band of the cell's carrier is configured Uplink sub-bands, while the middle-frequency sub-band of the same cell's carrier is configured as a downlink sub-band. One or more guard-band (i.e., unused frequency resources) may be configured at the edge of the cell's carrier or in between sub-bands.

A WTRU may receive configurations of (e.g., may be configured with) SBFD sub-band time locations that may be configured within a period. In an example, the period may be the same as a TDD-UL-DL pattern period configured by dl-UL-TransmissionPeriodicity, e.g., in TDD-UL-DL-ConfigCommon. In another example, the period may be an integer multiple of TDD-UL-DL pattern period configured by dl-UL-TransmissionPeriodicity, e.g., in TDD-UL-DL-ConfigCommon.

When a (e.g., one, only one) TDD-UL-DL pattern is configured, SBFD symbols may be configured in consecutive manner within a TDD-UL-DL pattern period. When two TDD-UL-DL patterns are configured and if SBFD symbols are configured for only one of the patterns, SBFD symbols may be configured in consecutive manner within the TDD-UL-DL pattern period. When two TDD-UL-DL patterns are configured and if SBFD symbols are configured for both patterns, SBFD symbols may be configured in consecutive manner within each TDD-UL-DL pattern period.

A WTRU may be configured with one or more SBFD configurations changing over time. The WTRU may receive multiple configurations for different SBFD patterns, such as one or more DU, UD, DUD or UDU patterns. The WTRU may receive the configuration to apply a time pattern where different SBFD configurations are used over time. In an example, the period may be the same as a TDD-UL-DL pattern period configured by dl-UL-TransmissionPeriodicity, e.g., in TDD-UL-DL-ConfigCommon. In another example, the period may be an integer multiple of TDD-UL-DL pattern period configured by dl-UL-TransmissionPeriodicity, e.g., in TDD-UL-DL-ConfigCommon.

A WTRU may be configured with dedicated SBFD configuration, where the WTRU receives, for example, via RRC dedicated signaling, the SBFD configuration to apply on selected time resources. This may apply the same pattern and periods as the RRC (re)configuration TDD-UL-DL-ConfigDedicated field.

A WTRU may be configured with multiple (serving) cells, e.g., for Carrier Aggregation (CA), and in the case of Dynamic SBFD configuration, the WTRU may be configured with different SBFD configuration at the same time across different cells.

In the network, geographically neighboring cells (that may be controlled by different gNBs or nodes) may be configured with independent SBFD configuration, for example, using different SBFD patterns and/or different sub-band size and position configuration. The network may be able to exchange information about the configuration of the different cells between gNBs.

A WTRU may determine (or be indicated/configured with) that ‘UL usable PRBs’ are a part of UL sub-band frequency resources within an UL BWP (e.g., an active UL BWP, a currently active UL BWP), and ‘DL usable PRBs’ are a part of DL sub-band frequency resources within an DL BWP (e.g., an active DL BWP, a currently active DL BWP). The UL usable PRBs may be determined as an intersection between a configured or indicated UL sub-band and an active UL BWP in SBFD symbols (and/or slots). The DL usable PRBs may be determined as an intersection between a configured or indicated DL sub-band(s) and an active DL BWP in SBFD symbols (and/or slots). In an (e.g., another) example, the UL and/or DL usable PRBs may be explicitly configured within active UL and/or DL BWP, e.g., in SBFD symbols and/or slots.

In an example, a WTRU may receive information on frequency resource allocation (e.g., Type 0 as RBG-level bitmap-based resource assignment) for a PDSCH or PUSCH (as being scheduled) in a slot(s). When an assigned RBG overlaps with a sub-band boundary, the UE may determine that (only) the PRBs within DL usable PRBs are to be valid for PDSCH reception and (only) the PRBs within UL usable PRBs are to be valid for PUSCH transmission, e.g., where this may imply “partial RBG” is allowed and valid for resource allocation.

A WTRU may report a subset of channel state information (CSI) components, where CSI components may correspond to at least a CSI-RS resource indicator (CRI), a SSB resource indicator (SSBRI), an indication of a panel used for reception at the UE (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

A WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during initial access, initial synchronization, radio link monitoring (RLM), cell search, cell switching, and so forth.

A WTRU may measure and report the channel state information (CSI), wherein the CSI for each connection mode may include or be configured with one or more of following:

CSI Report Configuration, including one or more of the following:

CSI report quantity, e.g., Channel Quality Indicator (CQI), Rank Indicator (RI), Precoding Matrix Indicator (PMI), CSI-RS Resource Indicator (CRI), Layer Indicator (LI), etc. ; CSI report type, e.g., aperiodic, semi persistent, periodic; CSI report codebook configuration, e.g., Type I, Type II, Type II port selection, etc. ; and CSI report frequency.

CSI-RS Resource Set, including one or more of the following CSI Resource settings: NZP-CSI-RS Resource for channel measurement; NZP-CSI-RS Resource for interference measurement; and CSI-IM Resource for interference measurement.

ZP CSI-RS Resources, including one or more of the following: NZP CSI-RS Resource ID; periodicity and offset; QCL Info and TCI-state; and resource mapping, e.g., number of ports, density, CDM type, etc.

A WTRU may indicate, determine, or be configured with one or more reference signals. The WTRU may monitor, receive, and measure one or more parameters based on the respective reference signals. For example, one or more of the following parameters may apply: SS-RSRP, CSI-RSPR, SS-SNIR, CSI-SINR, RSSI, and SRS-RSRP. These parameters are non-limiting examples of the parameters that may be included in reference signal(s) measurements. One or more of these parameters may be included, and other parameters may be included.

SS reference signal received power (SS-RSRP) may be measured based on the synchronization signals (e.g., demodulation reference signal (DMRS) in PBCH or SSS). It may be defined as the linear average over the power contribution of the resource elements (RE) that carry the respective synchronization signal. In measuring the RSRP, power scaling for the reference signals may be required. In case SS-RSRP is used for L1-RSRP, the measurement may be accomplished based on CSI reference signals in addition to the synchronization signals.

CSI-RSRP may be measured based on the linear average over the power contribution of the resource elements (RE) that carry the respective CSI-RS. The CSI-RSRP measurement may be configured within measurement resources for the configured CSI-RS occasions.

SS signal-to-noise and interference ration (SS-SINR) may be measured based on the synchronization signals (e.g., DMRS in PBCH or SSS). It may be defined as the linear average over the power contribution of the resource elements (RE) that carry the respective synchronization signal divided by the linear average of the noise and interference power contribution. In case SS-SINR is used for L1-SINR, the noise and interference power measurement may be accomplished based on resources configured by higher layers.

CSI-SINR may be measured based on the linear average over the power contribution of the resource elements (RE) that carry the respective CSI-RS divided by the linear average of the noise and interference power contribution. In case CSI-SINR is used for L1-SINR, the noise and interference power measurement may be accomplished based on resources configured by higher layers. Otherwise, the noise and interference power may be measured based on the resources that carry the respective CSI-RS.

Received signal strength indicator (RSSI) may be measured based on the average of the total power contribution in configured OFDM symbols and bandwidth. The power contribution may be received from different resources (e.g., co-channel serving and non-serving cells, adjacent channel interference, thermal noise, and so forth).

Cross-Layer interference received signal strength indicator (CLI-RSSI) may be measured based on the average of the total power contribution in configured OFDM symbols of the configured time and frequency resources. The power contribution may be received from different resources (e.g., cross-layer interference, co-channel serving and non-serving cells, adjacent channel interference, thermal noise, and so forth). In the case where L1-CLI-RSSI is used, the WTRU does not perform L3 filtering over multiple measurement samples, which may help identify time bursts of interferences.

Sounding reference signals RSRP (SRS-RSRP) may be measured based on the linear average over the power contribution of the resource elements (RE) that carry the respective SRS. In the case where L1-SRS-RSRP is used, the WTRU does not perform L3 filtering over multiple measurement samples, which may help identify time bursts of interferences.

Hereafter, wordings such as “the WTRU is configured”, “the WTRU is preconfigured”, “the WTRU received a configuration”, “the WTRU received a pre-configuration”, may be used interchangeably, meaning that the WTRU received an indication from the network, either from RRC (re)configuration, MAC indication, DCI signaling or MIB/SIB indication, which can be explicit or implicit, based on the specification, or that the WTRU has an internal setting or default setting of the configuration without additional network signaling.

A WTRU may receive configurations (e.g., from a gNB, a node, or a device) for full-duplex (FD) operation conducted by at least one device in a network. In an example, the FD operation may be conducted by a gNB (e.g., a BS, a node, a TRP, a cell). The WTRU may operate in a half-duplex (HD) mode for communicating with the gNB, where the HD mode may imply at a given time the UE either performs a UL transmission or a DL reception (not both simultaneously at the given time). The WTRU may (also) operate in an FD mode for communicating with the gNB, e.g., if a corresponding UE capability signal(s) is reported to the gNB and/or the WTRU receives a confirmation signal (e.g., enabling the FD, configuring the FD mode) in response to transmitting the WTRU capability signal(s).

The FD operation may imply at a given time a transmitter (e.g., the gNB and/or the WTRU) may simultaneously transmit a first signal and receive a second signal. The FD operation may comprise a sub-band overlapping FD (e.g., in-band FD (IBFD)) operation where a first frequency-domain resource (e.g., RBG(s), RB(s), RE(s)) allocated for the first signal may have a full (or at least a partial) overlap with a second frequency-domain resource allocated for the second signal. The FD operation may comprise a sub-band non-overlapping FD (SBFD) operation where a first frequency-domain resource allocated for the first signal (e.g., assigned within a configured SBFD sub-band, e.g., DL sub-band, usable DL PRBs) does not have an overlap with a second frequency-domain resource allocated for the second signal (e.g., assigned within a configured SBFD sub-band, e.g., UL sub-band, usable UL PRBs).

Hereafter, for the brevity of discussion, the FD operation may comprise the SBFD operation, however the described techniques and processes may equally (or equivalently or extendedly, etc.) be employed for cases with other FD operation types (e.g., IBFD, etc.).

A WTRU may receive SBFD-related configuration(s), e.g., for frequency-domain location information of one or more sub-bands (e.g., DL sub-band, UL sub-band, flexible DL/UL sub-band, and/or guard-band), and/or for time-domain location information of the one or more sub-bands. The time-domain location information may indicate a set of non-SBFD symbols and a set of SBFD symbols (e.g., as illustrated in FIG. 4). A symbol(s) within the set of non-SBFD symbols may be a type of ‘DL symbol’, ‘UL symbol’ or ‘flexible symbol’. The WTRU may receive a DL signal on symbol(s) based on a type of ‘DL symbol’ in the set of non-SBFD symbols. The WTRU may transmit a UL signal on symbol(s) based on a type of ‘UL symbol’ in the set of non-SBFD symbols. The UE may either receive a DL signal or transmit a UL signal on symbol(s) based on a type of ‘flexible symbol’ in the set of non-SBFD symbols, e.g., depending on one or more conditions with other signal(s) co-existing in the symbol(s).

A WTRU may receive an indication of a (re)configuration of the duplexing directions/patterns for its configured cell(s). For instance, the WTRU may receive a SIB (SIB1) message on a cell or RRC (re)configuration indicating a duplexing (re)configuration for the different time resources of a cell, for instance, via the tdd-UL-DL-Configuration common parameter (re)configuration, e.g., which slots and/or symbols are in the Uplink direction and which are in the Downlink direction. The time resource may also be configured as Flexible, where the time resource is dynamically or semi-statically configured by the network and/or given through dedicated WTRU configuration.

As an example, the WTRU may receive an indication about common SBFD configuration of a cell, e.g., through SIB (e.g. SIB1) or through RRC (re)configuration. The WTRU may then be configured with slots and symbols that are either ‘DU’, ‘UD’, ‘DUD’, ‘UDU’, or regular downlink or uplink configuration.

As another example, the WTRU may receive a dedicated configuration indicating an update of the duplexing direction of a cell for selected time resources (slots/symbols), e.g., via the RRC (re)configuration TDD-UL-DL-ConfigDedicated field.

As another example, the WTRU may receive an indication about dedicated SBFD configuration of a cell for selected time resources (slots/symbols), through RRC, MAC or DCI (re)configuration. The WTRU may then be configured with slots and symbols that are either ‘DU’, ‘UD’, ‘DUD’, ‘UDU’, or regular downlink or uplink configuration.

A WTRU may receive (re)configurations for Dynamic SBFD configuration, where different time resources are configured to apply different SBFD configurations. For example, one slot or symbol may be configured with a first SBFD pattern (e.g., ‘DU’) and another slot or symbol may be configured with a second SBFD pattern (e.g., ‘UD’), within the configuration period. In another example, the WTRU may be configured so that one slot or symbol is applying a first configuration of ‘DU’ pattern (e.g., with a first split of the frequency resources between the Downlink, Uplink and guard band if any), and another slot/symbol is configured with a second configuration of the ‘DU’ pattern (e.g., with a second split of the frequency resources between the Downlink, Uplink and guard band if any).

A WTRU may receive configurations for Bandwidth Adaption in which the WTRU is configured with multiple Bandwidth Parts (BWPs). A BWP consists in a subset of the total bandwidth of a cell, e.g., as a number and starting position of PRBs. A WTRU may have multiple BWPs configured for UL or DL. A WTRU may be configured with active BWP(s) and the (de)activation of BWPs may be following a (pre)configured time pattern or be dynamically (e.g., using DCI or MAC CE indication) signaled.

A WTRU may receive a (pre)configuration indicating the configurations for which the WTRU may expect CLIs. The (pre)configuration may include several types of CLIs, for instance: co-channel CLI, which may be CLI happening when another WTRU transmits on the same frequency resources (at the same time, e.g., for UEs in neighboring cells); SBFD leakage CLI:, which may be CLI happening when the WTRU is receiving DL while another WTRU transmits on the UL sub-band of the same cell, generating interference leakage in frequency adjacent sub-bands, e.g., when the cell is configured SBFD; and inter-carrier CLI leakage, which may be CLI happening when the WTRU is receiving DL while another WTRU transmits on an UL (sub)band of the frequency adjacent cell/carrier, generating interference leakage in frequency adjacent cell, e.g., when multiple cells are configured with dynamic TDD, SBFD and/or Carrier Aggregation.

The (pre)configuration may include indications of the configurations for which CLI may occur at the UE, for each type of CLIs, based on the SBFD/duplexing configuration. Examples include:

A Co-channel CLI may be indicated when, for a given time resource, the WTRU's serving cell is ‘DU’ while a neighboring cell is ‘UD’ or ‘Uplink,’ the WTRU's serving cell is ‘UD’ while a neighboring cell is ‘DU’ or ‘Uplink,’ the WTRU's serving cell is ‘DUD’ while a neighboring cell is ‘DU’, ‘UD’, ‘UDU’, or ‘Uplink,’ the WTRU's serving cell is ‘UDU’ while a neighboring cell is ‘DU’, ‘UD’, ‘DUD’, or ‘Uplink,’ the WTRU's serving cell is ‘DL’ while a neighboring cell is ‘DU’, ‘UD’, ‘DUD’, ‘UDU’ or ‘Uplink, and the DL sub-band of the serving cell overlaps in frequency with the UL sub-band of a neighboring cell

A SBFD leakage CLI may be indicated when, for a given time resource, the WTRU's serving cell is ‘DU,’ the WTRU's serving cell is ‘UD,’ the WTRU's serving cell is ‘DUD,’ the WTRU's serving cell is ‘UDU,’ and/or when the frequency distance between the UL sub-band and the DL sub-band of the serving cell is below a (pre)configured threshold.

A Inter-carrier CLI leakage may be indicated when, for a given time resource, the WTRU's serving cell is ‘DL’ and a frequency adjacent cell is configured with an UL sub-band (or as an UL symbol/slot) on the common frequency edge, the WTRU's serving cell is ‘UD’, ‘DU’ or ‘DUD’ and a frequency adjacent cell is configured with an UL sub-band (or as an UL symbol/slot) on the frequency edge adjacent to the DL sub-band, and/or when the frequency distance between the UL sub-band and the DL sub-band of the serving cell is below a (pre)configured threshold.

A WTRU may receive a (pre)configuration to perform measurement and reporting of the CLI, where, for example: the WTRU receives the indication to perform CLI-RSSI measurements, to evaluate the overall received power on a selection of resources (e.g., REs/RBs) over one or multiple symbols indicated in the received configuration; the WTRU receives the indication to perform SRS-RSRP measurements, to evaluate the power contribution of a specific WTRU, on a selection of resources (e.g., REs/RBs) over one or multiple symbols indicated in the received configuration (including the SRS configuration such as comb, resources, IDs); and the WTRU receives the indication to perform non-CLI measurements, but a measurement to be used as a proxy for CLI. Hereafter, any CLI-measurement may also equivalently refer to a non-CLI measurement used as a proxy for CLI using one of the following examples: where the WTRU may be configured to measure CSI for Interference Management (CSI-IM) with the corresponding CSI-IM resources that measure the interference from neighboring cells; where the WTRU may also be configured to measure CSI-RS configured as Zero-Power (ZP-CSI-RS), to be able to measure the noise/interference from neighboring cells; and where the WTRU may also be configured to measure the neighboring cell using e.g., SSB measurements.

The WTRU may be configured to perform L1-based measurements (e.g. L1-CLI-RSSI, L1-SRS-RSRP, L1-CSI-IM, L1-CSI-RS . . . ) or higher layer-based measurements (e.g., CLI-RSSI, SRS-RSRP, L1-CSI-IM, L1-CSI-RS . . . ), where the L1-based measurement is not averaged over multiple time resources, to evaluate instantaneous interference.

The WTRU may be configured with the measurement resources on different parts of the SBFD sub-bands: in one example, the resources to perform the measurement are located on a DL sub-band of the configured SBFD pattern, at least for some time resources, in another example, the resources to perform the measurement are located on a UL sub-band of the configured SBFD pattern, at least for some time resources, and in another example, the resources to perform the measurement are located on a guard-band of the configured SBFD pattern (if any), at least for some time resources.

The WTRU may receive the indication to perform a CLI measurement using a specific receiver beam (e.g., spatial transformation), using the receiver beam corresponding to a known DL transmission (e.g., using a TCI/QCL reference). For example, the WTRU may be indicated to perform measurement using a RX beam similar to the RX beam used for a given RS (e.g., a PSCCH or PSSCH DMRS, SSB, PTRS, etc.); or it could be configured to use the same beam as it uses to perform an UL transmission, e.g., the same beam as for a PUSCH/PUCCH/RACH transmission. The indication may be given together with the CLI measurement configuration, e.g., via RRC, MAC, DCI configuration, and may also be (re)configured afterwards, for a given or all CLI measurements configurations, e.g., by RRC, MAC or DCI indications.

The WTRU may receive the indication (implicit or explicit) to perform a CLI measurement using a wideband measurement and reporting, i.e., where the measured quantity is averaged over all the configured measurement resources in the frequency domain. The WTRU reports the quantity for the entire CLI measurement resources.

The WTRU may receive the indication (implicit or explicit) to perform a CLI measurement using a sub-band measurement and reporting, i.e., where the perform separated measurements and generates multiple reporting quantity for different parts of the frequency domain of the configured measurement resource. The WTRU may receive the indication of the reporting sub-band size (e.g. a number of RBs per reporting sub-band, e.g., 4, 8, 16, that may be dependent on the carrier/BWP/sub-band size). The WTRU may report the measured quantity for one or multiple reporting sub-bands, including the quantity and its associated sub-band, e.g., referred to with a sub-band index. The sub-band reporting may be beneficial to use to evaluate the frequency selectivity of the interference.

The WTRU may receive the indication that the CLI measurement is configured with a periodic, semi-persistent or aperiodic reporting. The WTRU may receive this configuration via RRC (re)configuration or pre-configuration. Periodic reporting are active until the WTRU receives a further (re)configuration of the measurement. The WTRU may be indicated to start/stop (activate/deactivate) a semi-persistent reporting, e.g., using RRC/MAC or DCI indication. Periodic and semi-persistent reporting configuration include the resources indications (e.g., on PUCCH or PUSCH) on which to transmit the reports and, the time period between two reports, e.g. expressed in ms. Aperiodic measurement configurations may include a time/frequency resource indication and the UE further receive indications from the network, e.g., via MAC or DCI indication, to perform the aperiodic measurement. The UE may also be configured with autonomous reporting, where the UE determines to report the CLI based on triggers.

The WTRU receive a configured threshold associated with a CLI measurement and the WTRU measured a CLI that is beyond that threshold. The WTRU may then report the corresponding CLI measurement, including measurement ID (or the corresponding resources) and measurement quantities/values, and the WTRU is (pre)configured with a timer, e.g., that is (re)started when the WTRU received the configuration and/or the WTRU reported the measurement; and the WTRU may be configured to transmit the report when the timer expires.

The WTRU may receive a configuration of a CLI measurement and report associated with a threshold (e.g., based on CLI-RSSI, SRS-RSRP, L1-CLI-RSSI or L1-SRS-RSRP). The WTRU may use the threshold as a condition to trigger, e.g., WTRU reporting of the measurement. The WTRU may be configured with one or more thresholds for a given measurement.

For example, a first threshold is applicable for L1-SRS-RSRP measurements while a second threshold is applicable for L1-CLI-RSSI measurements. In another example, a first threshold may apply for a measurement over more than a first number of RBs and a second threshold may apply for a measurement over more than a second number of RBs. In another example, a first threshold may apply for a wideband measurement and reporting configurations, and a second threshold may apply for a sub-band-based measurement and reporting.

It should be noted that although the technological description and technological features described herein are mainly presented for (L1-)CLI-RSSI measurement and measurement resources, the same is also applicable for (L1-)SRS-RSRP measurements and resources.

In one general aspect, the WTRU may receive a (pre)configuration where a measurement and reporting configuration that includes several measurement resources, e.g., a pool of resources for measurement, and the measurements or measurement resource usage may be associated with cells configuration to ensure that the WTRU may measure CLI on these resources. In some examples, the WTRU may receive a CLI measurement and reporting (pre)configuration including a set/pool of resources.

The WTRU may receive a (L1-)CLI-RSSI measurement configuration with multiple CLI measurement resources, e.g., in different parts of the serving cell frequency and/or in different time resources (symbols/slots). The different resources may be included in a limited time window, e.g., within a single slot or within a set of slots. In one example, the WTRU may receive a CLI measurement resource in a first symbol of a slot, and a second CLI measurement resource in a second symbol of a slot, e.g., using different startPosition parameters. In another example, the WTRU may receive a CLI measurement resource in a first frequency part (e.g., closer to a frequency edge of the cell's carrier), and a second CLI measurement resource in a second frequency part (e.g., spanning over the whole cell's carrier frequency), e.g., using different startPRB and parameters.

The WTRU may receive a (L1-)SRS-RSRP measurement configuration with multiple SRS resources for measurements, e.g., in different parts of the serving cell frequency and/or in different time resources (symbols/slots) and/or with different resource configurations. The different resources may be included in a limited time window, e.g., within a single slot or within a set of slots.

In an example, the WTRU may receive a first SRS resource for CLI measurement in a first symbol of a slot, and a second SRS resource for CLI measurement in a second symbol of a slot, e.g., using different startPosition parameter in SRS-Resource. In another example, the WTRU may receive a first SRS resource for CLI measurement in a first frequency part (e.g., closer to a frequency edge of the cell's carrier), and a second SRS resource for CLI measurement in a second frequency part (e.g., spanning over the whole cell's carrier frequency), e.g., using different freqDomainPosition, freqDomainShift or freqHopping parameters. In another example, the WTRU may receive a first SRS resource for CLI measurement with a first sequenceId parameter and a second SRS resource for CLI measurement with a second sequenceId parameter. In yet another example, the WTRU may receive a first SRS resource for CLI measurement with a first transmissionComb parameter and a second SRS resource for CLI measurement with a second transmissionComb parameter.

The WTRU may receive the set/pool of resources in a listed order. The WTRU may receive the set/pool of resources where each resource is associated with a resource ID. The WTRU may receive prioritization rule(s) associated with the set/pool of resource indicating, for example, how to (down)select the resources. E.g., based on the resource itself (resource ID, index in an ordered list, resource timing, etc.) and/or a CLI type. In an example the WTRU receives the (pre)configuration of an order of priority between the CLI types (e.g., SBFD CLI-leakage>co-channel CLI>inter-carrier CLI leakage).

The WTRU may receive a maximum number of measurements that the reporting configuration may support for that CLI measurement and reporting configuration. In an example, a WTRU may receive a (pre)configuration associating a CLI measurement configuration to cell(s), and/or their duplexing configurations (e.g., SBFD vs non-SBFD, position of the UL sub-band, etc.) where the WTRU receives a configuration associating a measurement configuration to a WTRU's serving cell duplexing/SBFD pattern on the time of the resource. For example, the measurement on the resource(s) may be conditioned to the WTRU's serving cell being configured as SBFD, e.g., “DU”, “UD”, “DUD”, “UDU.” In another example, the measurement on the resource(s) may be conditioned to the WTRU's serving cell being configured so that the resource lies within the downlink sub-band of the SBFD cell. In another example, the measurement on the resource(s) may be conditioned to the WTRU's serving cell being configured as DL.

In another example, the WTRU may receive a (pre)configuration associating a CLI measurement configuration to cell(s), and/or their duplexing configurations that may include a measurement configuration where its resource is associated to another cell duplexing/SBFD pattern on the time of the resource. For example, the other cell may be a neighboring cell in the network, e.g., identified by a Cell ID, the other cell may be a frequency adjacent cell controlled by the serving gNB, e.g., identified by a Cell ID or frequency indication, the measurement on the resource(s) may be conditioned to the other cell being configured as SBFD, e.g., “DU”, “UD”, “DUD”, “UDU,” the measurement on the resource(s) may be conditioned to the other cell being configured so that the resource lies within the uplink sub-band of the SBFD cell, the measurement on the resource(s) may be conditioned to the WTRU's serving cell being configured as UL, or the configuration may be associated with multiple cells, conditioning the measurement to the presence of one or more of the conditions on these cells.

In another example, the WTRU may receive a (pre)configuration associating a CLI measurement configuration to cell(s), and/or their duplexing configurations including a measurement configuration where its resource is associated to both WTRU's serving cell and another cell's duplexing/SBFD pattern on the time of the resource, e.g., a combination of the two configurations.

This may include an explicit combination: the measurement on the resource(s) may be conditioned to a combination of duplexing/SBFD configurations between the serving cell and the other cell. For example, the measurement on the resource(s) may be conditioned to a combination of configuration where both the serving cell and the other cell are configured as SBFD cells, the measurement on the resource(s) may be conditioned to a combination of configuration the serving cell is configured as DL and the other cell as UL; and the measurement on the resource(s) may be conditioned to a combination of SBFD configurations where, for example, the WTRU's serving cell is ‘DU’ while the other cell is ‘UD’ or ‘Uplink,’ the WTRU's serving cell is ‘UD’ while the other cell is ‘DU’ or ‘Uplink,’ the WTRU's serving cell is ‘DUD’ while the other cell is ‘DU’, ‘UD’, ‘UDU’, or ‘Uplink,’ the WTRU's serving cell is ‘UDU’ while the other cell is ‘DU’, ‘UD’, ‘DUD’, or ‘Uplink,’ the WTRU's serving cell is ‘DL’ while the other cell is ‘DU’, ‘UD’, ‘DUD’, ‘UDU’ or ‘Uplink,’ the WTRU's serving cell is ‘DL’ and a frequency adjacent cell is configured with an UL sub-band (or as an UL symbol/slot) on the common frequency edge.

In another example, the WTRU may receive a (pre)configuration associating a CLI measurement configuration to cell(s), and/or their duplexing configurations that includes Sub-band overlap or distance: the measurement on the resource(s) may be conditioned to the distance between the UL (sub)band of the other cell and the DL (sub)band of the serving cell. For example, the measurement on the resource(s) may be conditioned if the UL (sub)band of the other cell and the DL (sub)band of the serving cell are overlapping (co-channel CLI), and the measurement on the resource(s) may be conditioned if the UL (sub)band of the other cell and the DL (sub)band of the serving cell is less than a frequency distance threshold (CLI leakage)

A WTRU may receive a (pre)configuration associating a CLI measurement configuration to cell(s), and/or a CLI type (e.g., Co-channel CLI, SBFD leakage CLI, Inter-carrier CLI leakage) for example: the measurement on the resource(s) may be conditioned to whether the configuration of the cell may generate SBFD leakage CLI; the measurement on the resource(s) may be conditioned to whether the configuration of the cell and the other cell may generate Co-channel CLI, where the measurement may be conditioned to a specific cell, to one of multiple cells, or to any cell; the measurement on the resource(s) may be conditioned to whether the configuration of the cell and the other cell may generate Inter-carrier CLI leakage where the measurement may be conditioned to a specific cell, to one of multiple cells, or to any cell.

A WTRU may receive a (pre)configuration associating a CLI measurement configuration to other configurations of the serving cell, such as beams. For example, the WTRU performs the measurement and/or select the resource when the WTRU is being served/actively configured with an associated beams, e.g., based on the serving cell's SSB, TCI-state, QCL or RX spatial filter associated with the CLI measurement or measurement resource.

The WTRU may receive the association between the CLI types/duplexing configurations and one or more specific resource(s) of the resource pool of the measurement configuration. For example, different resources within a pool of resources of a given measurement configuration may be configured with one or more different associations/conditions. Examples include: configuration of the serving cell, a first resource may be associated with the case where the WTRU's serving cell is SBFD UD while a second resource be associated with the case where the WTRU's serving cell is SBFD DU; configuration of another cell, a first resource may be associated with the case where the other cell is SBFD UD while a second resource may be associated with the case where the other cell is SBFD DU; CLI type, a first resource may be associated with the case where the combination of SBFD patterns lead to SBFD leakage CLI, while a second resource may be associated with the case where the combination of SBFD patterns leads to co-channel CLI; Beam/TCI-state, a first resource may be associated with the case where the WTRU is configured with a first beam/TCI state while a second resource may be associated with the case where the WTRU is configured with a second beam/TCI state; and the configuration may be in the form of a mapping.

This is where the WTRU may receive a mapping between the configuration of cell(s) and the resource to use for that measurement. Examples include: a first resource may be mapped to the case where the WTRU's serving cell is SBFD UD while a second resource may be mapped to the case where the WTRU's serving cell is SBFD DU, a first resource may be mapped to the case where the other cell is SBFD UD while a second resource may be mapped to the case where the other cell is SBFD DU, a first resource may be mapped to the case where the combination of SBFD patterns lead to SBFD leakage CLI, while a second resource may be mapped to the case where the combination of SBFD patterns leads to co-channel CLI, a first resource may be mapped to the case where the WTRU is configured with a first beam/TCI state while a second resource may be mapped to the case where the WTRU is configured with a second beam/TCI state; the mapping may be associating one resource to one or more conditions; and the mapping may be associating one condition to one or more resources.

In an example embodiment, the WTRU may receive an (re)configuration of the duplexing/SBFD configuration of its serving cell, e.g., via a SIB, RRC, MAC or DCI indication, (re)configuring the duplexing direction and/or sub-bands configurations (direction, position, size), on some or all of the time resources. The (re)configuration may be cell-specific and/or WTRU specific.

In an example embodiment, the WTRU may receive a (re)configuration of the duplexing/SBFD configuration of another cell, via indication from the network, e.g., its serving cell signaling the configuration of another cell via RRC, MAC or DCI indication. The WTRU may receive the configuration of another cell that is, for example, a secondary cell, a frequency-adjacent cell, or a neighboring cell. The WTRU may be configured to be served with the other cell, e.g., using Carrier Aggregation. The cells may be identified, e.g., using their cell ID, frequency position, location, etc.

In another example embodiment, the WTRU may receive a (re)configuration of the duplexing/SBFD configuration of another cell, by receiving an indication from that other cell, e.g., receiving a SIB, RRC, MAC or DCI indication. For example, the WTRU may be configured with Carrier Aggregation and the WTRU receives the (re)configuration from a secondary cell and/or the WTRU may be (pre)configured to monitor MIB/SIB from other cells (e.g., frequency-adjacent cells, neighboring cells) and receives the cell-specific duplexing/SBFD configuration of the other cells.

In an embodiment, when the WTRU receives the indication of a (re)configuration of the duplexing/SBFD of another cell, but not signaled by the serving cell, the WTRU may report to its serving cell the received (re)configuration, e.g., indicating the duplexing/SBFD configuration on the different time resources, and the corresponding cell (e.g., cell ID, frequency, etc.)

In an example embodiment, the WTRU may receive a configuration indicating that the measurement and reporting is associated with a CLI Type and includes a set of resources. The WTRU may determine the CLI type of each of the measurement resources based on the dynamic duplexing/SBFD configuration of the cell(s), and selects the resource that corresponds to the associated CLI type to perform the measurement and reporting.

In an example embodiment, the WTRU determines the type of CLI (e.g., Co-channel CLI, SBFD leakage CLI, Inter-carrier CLI leakage) expected on the configured measurement resources based on the received configuration of its serving cell and the other cells and based on each measurement resource (time/frequency position of the resource). In some examples, the UE may determine that: a measurement resource may be considered of type SBFD leakage CLI if the resource is configured in a SBFD time resource (e.g., DU, UD, DUD, UDU) and that the resource is in the DL sub-band frequency, a measurement resource may be considered of type SBFD leakage CLI if the resource is configured in a SBFD time resource (e.g., DU, UD, DUD, UDU) and that the frequency distance between an UL sub-band and the DL sub-band of the resource is less than a threshold; a measurement resource may be considered of type SBFD leakage CLI if the resource is configured in a SBFD time resource (e.g., DU, UD, DUD, UDU) and that the frequency distance between an UL sub-band and the resource in the DL sub-band is less than a threshold. ; and a measurement resource may be considered of type Co-channel CLI if it is in a configured DL (sub)band and any of: the WTRU's serving cell is ‘DU’ while a neighboring cell is ‘UD’ or ‘Uplink,’ the WTRU's serving cell is ‘UD’ while a neighboring cell is ‘DU’ or ‘Uplink,’ the WTRU's serving cell is ‘DUD’ while a neighboring cell is ‘DU’, ‘UD’, ‘UDU’, or ‘Uplink,’ the WTRU's serving cell is ‘UDU’ while a neighboring cell is ‘DU’, ‘UD’, ‘DUD’, or ‘Uplink,’ the WTRU's serving cell is ‘DL’ while a neighboring cell is ‘DU’, ‘UD’, ‘DUD’, ‘UDU’ or ‘Uplink,’ the DL sub-band of the serving cell overlaps in frequency with the UL sub-band of a neighboring cell.

The WTRU may determine that a measurement resource may be considered of type Inter-carrier CLI leakage if it is in a configured DL (sub)band and any of: the WTRU's serving cell is ‘DL’ and a frequency adjacent cell is configured with an UL sub-band (or as an UL symbol/slot) on the common frequency edge; the WTRU's serving cell is ‘UD’, ‘DU’ or ‘DUD’ and a frequency adjacent cell is configured with an UL sub-band (or as an UL symbol/slot) on the frequency edge adjacent to the DL sub-band, and/or when the frequency distance between the UL sub-band and the DL sub-band of the serving cell is below a (pre)configured threshold.

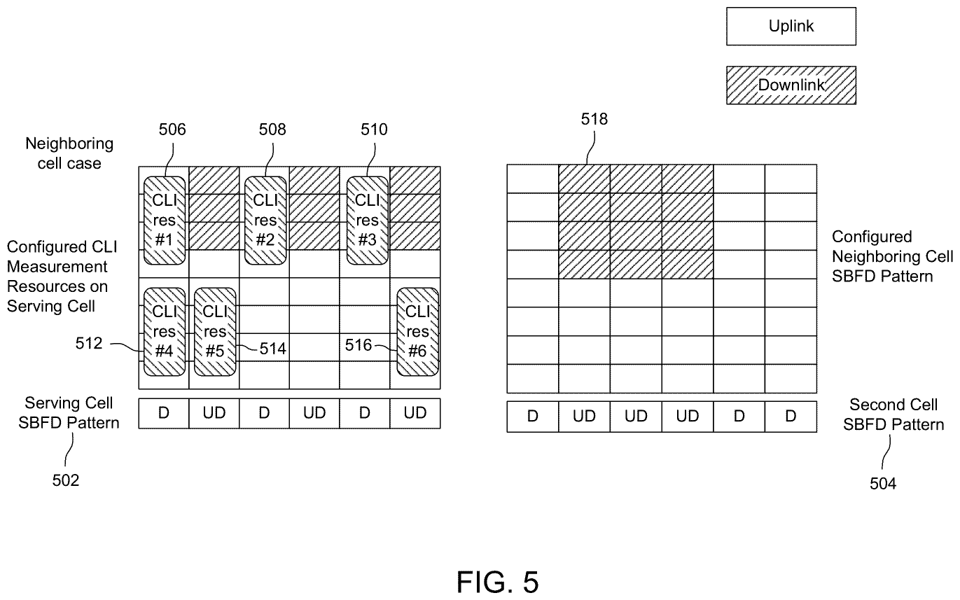

FIG. 5 illustrates an example of CLI type determination based on serving cell configuration and a neighboring (second) cell configuration. As illustrated in FIG. 5, the duplexing/SBFD configuration of a serving cell (left-side) 502 and of a neighboring cell (right-side) 504 is shown for various symbols/slots. The WTRU may determine that: CLI Resources #1 506, #3 510, and #4 512 do not measure CLI based on the serving cell being DL and the neighboring cell also being DL.

CLI resource #2 508 measures co-channel CLI based on the neighboring cell being UD at 518 while the serving cell is DL (and that the resource is in the overlap between neighboring UL sub-band and serving cell's DL). CLI resource #5 514 and #6 516 measures SBFD leakage CLI based on the serving cell being SBFD ‘UD’ and the resource on the DL part.

In an example embodiment, the WTRU received a configuration associating a measurement and reporting to a CLI type, including a set/pool of measurement resources. The WTRU may determine, among the configured measurement resources, if any of the determined type of CLI corresponds to the received associated type of CLI for the measurement and reporting.

In an example, the WTRU may determine that one of the resources is of a same CLI type as the associated CLI type of the measurement and reporting configuration. The WTRU selects that one resource for measurement.

In the example illustrated in FIG. 5, if the WTRU is configured with a measurement and report associated to the CLI type of Co-channel CLI, the WTRU selects the CLI resource #2 508.

In an example, the WTRU may determine that none of the resources is of a same CLI type as the associated CLI type of the measurement and reporting configuration. The WTRU determines that no resource is suitable and may later skip the measurement.

In another example, the WTRU may determine that more than one of the resources is of a same CLI type as the associated CLI type of the measurement and reporting configuration. The WTRU may select one of the corresponding resources for measurement, based on received/(pre)configured priority rules. For example, based on received the resource order, e.g., the WTRU selects the first one in an ordered list of resource that is satisfying, based on resource time position, e.g., select the resource that has the earliest time symbol, based on resource ID, e.g., the WTRU selects the resource with lowest ID. In the example illustrated in FIG. 5, if the WTRU is configured with a measurement and report associated to the CLI type of SBFD leakage CLI, configured with a prioritization based on lowest resource ID first, and may only select one resource, the WTRU would select the CLI resource #5.

In another example, if the WTRU received a configuration that the measurement and reporting supports measurement on multiple resources, the WTRU may select up to the configured maximum number of measurement resources, e.g., following above-mentioned priority rules to up to the maximum number of resources.

In another example, the WTRU received a configuration of a measurement and reporting where the measurement resources are individually associated to a CLI type, the WTRU may determine, among the configured measurement resources, if any of the determined type of CLI of the resource corresponds to the received associated type of CLI for that resource.

In an example, the WTRU determines that one of the resources is of a same CLI type as the configured associated CLI type. The WTRU selects that one resource for measurement.

In another example, the WTRU determines that none of the resources is of a same CLI type as the configured associated CLI type. The WTRU determines that no resource is suitable and may later skip the measurement.

In another example, the WTRU determines that more than one of the resources is of the a CLI type as the configured associated CLI type. The WTRU selects one of the corresponding resources for measurement, based on received/(pre)configured priority rules, for example: based on received the resource order, e.g., the WTRU selects the first one in an ordered list of resource that is satisfying; based on resource ID, e.g., the WTRU selects the resource with lowest ID; based on resource time position, e.g., select the resource that has the earliest time symbol; and based on the CLI type priority order. In one example, the WTRU may receive a (pre)configuration indicating the priority order of the different CLI types (e.g., SBFD CLI-leakage>co-channel CLI>inter-carrier CLI leakage), and two resources are matching their configured associated CLI types, e.g., a SBFD leakage CLI measurement and a co-channel CLI measurement. In that case, the WTRU may select the SBFD leakage CLI based on the CLI type priority.

In an example, if the WTRU received the configuration that the measurement and reporting supports measurement on multiple resources, the WTRU may select up to the configured maximum number of measurement resources, e.g., following above-mentioned priority rules to up to the maximum number of resources.

In another example embodiment, the WTRU may receive a configuration indicating that the measurement and reporting is associated with the duplexing/SBFD configuration of the serving cell and includes a set of resources. The WTRU may determine the measurement resources based on the dynamic duplexing/SBFD configuration of the serving cell by selecting the resource that corresponds to the associated duplexing/SBFD configuration at the time of the resource to perform the measurement and reporting.

In another example, the WTRU may receive a configuration associating a measurement and reporting to a duplexing/SBFD configuration including a set/pool of measurement resources. The WTRU may determine, among the configured measurement resources, if any of the symbols/slots of the resource corresponds to the received associated duplexing/SBFD configuration of the measurement and reporting.

In another example, the WTRU may determine that one of the resources is of the same duplexing/SBFD as the associated duplexing/SBFD of the measurement and reporting configuration. The WTRU may select that one resource for measurement.

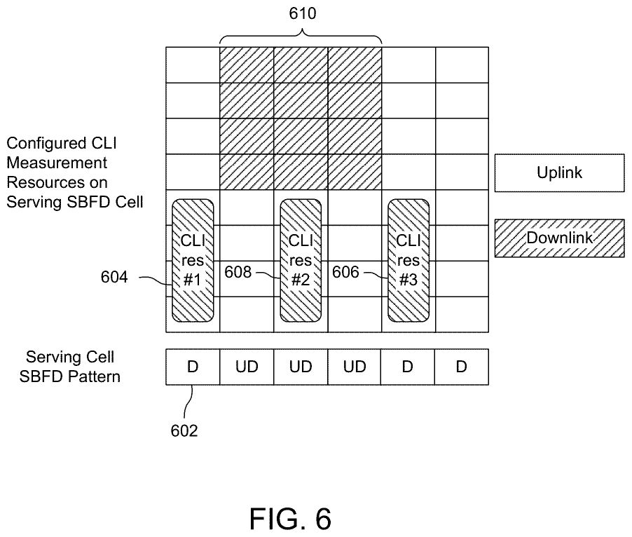

FIG. 6 illustrates an example of CLI resource selection based on the serving cell SBFD pattern. As illustrated in FIG. 6, SBFD pattern 602 includes three UD SBFD patterns (610), and three measurement resources, 604-606, are configured for a measurement and reporting configuration. CLI resource #1 604, CLI resource #2 606, and CLI resource #3 608.

CLI resource #2 608 is associated with a ‘UD’ SBFD pattern. At the time of measurement, the dynamic SBFD configuration may be such that only the CLI resource #2 608 is on a ‘UD’ symbol, thus, the WTRU may select CLI resource #2, 608. In an example, the WTRU may determine that none of the resources is of the same duplexing/SBFD as the associated duplexing/SBFD of the measurement and reporting configuration. The WTRU may determine that no resource is suitable and may later skip the measurement.

In an example, the WTRU may determine that more than one of the resources is of the same duplexing/SBFD as the associated duplexing/SBFD of the measurement and reporting configuration. The WTRU may select one of the corresponding resources for measurement, based on received/(pre)configured priority rules, e.g.: based on received the resource order, e.g., the WTRU selects the first one in an ordered list of resource that is satisfying; based on resource ID, e.g., the WTRU selects the resource with lowest ID; or based on resource time position, e.g., select the resource that has the earliest time symbol.

In one example, if the WTRU received the configuration that the measurement and reporting supports measurement on multiple resources, the WTRU may select up to the configured maximum number of measurement resources, e.g., following above-mentioned priority rules to up to the maximum number of resources. The WTRU may be configure to perform measurement result averaging across the multiple resources that are of the same duplexing/SBFD. The measurement result averaging may be associated with a weighted-averaging function where the WTRU may receive configuration of one or more parameters for the weighted-averaging function, e.g., a time-domain moving-average function. In an example, the time-domain moving-average function may be prioritizing more recent (in time domain) measurement resource, where a larger coefficient value may be multiplied to the more recent measurement to be averaged with a second measurement (being multiplied with a smaller coefficient value) prior to the more recent measurement.

In an example embodiment, the WTRU may receive a configuration of a measurement and reporting where the measurement resources are individually associated to a duplexing/SBFD. The WTRU may determine, among the configured measurement resources, if any of the determined type of CLI of the resource corresponds to the received associated type of CLI for that resource. In an example, the WTRU determines that one of the resources is of the same duplexing/SBFD as the configured associated duplexing/SBFD. The WTRU selects that one resource for measurement. In an example, the WTRU determines that none of the resources is of a same CLI type as the configured associated duplexing/SBFD. The WTRU determines that no resource is suitable and may later skip the measurement. In an example, the WTRU may determine that more than one of the resources is of the same duplexing/SBFD as the configured associated duplexing/SBFD. The WTRU selects one of the corresponding resources for measurement, based on received/(pre)configured priority rules, e.g.: based on received the resource order, e.g., the WTRU selects the first one in an ordered list of resource that is satisfying, based on resource ID, e.g., the WTRU selects the resource with lowest ID; or based on resource time position, e.g., select the resource that has the earliest time symbol.

In an example embodiment, the WTRU may receive a configuration indicating that the measurement and reporting is associated with a combination of duplexing/SBFD configurations of the serving cell and another cell includes a set of resources. The WTRU may determine the measurement resources based on the dynamic duplexing/SBFD configuration of the serving cell and the other cell, by selecting the resource that corresponds to the associated duplexing/SBFD configuration combination at the time of the resource to perform the measurement and reporting.

In an example, the WTRU may receive a configuration associating a measurement and reporting to a combination of duplexing/SBFD configurations including a set/pool of measurement resources. The WTRU may determine, among the configured measurement resources, if any of the symbols/slots of the resource corresponds to the received associated duplexing/SBFD configuration combination of the measurement and reporting.

In another example, the WTRU may determine that one of the resources is of same duplexing/SBFD combination as the associated duplexing/SBFD of the measurement and reporting configuration. The WTRU may select that one resource for measurement.

With reference to FIG. 5, six measurement resources are configured for a measurement and reporting configuration, for example, associated with a combination of DL on the serving cell and ‘UD’ SBFD on the neighboring cell. At the time of measurement, the dynamic SBFD configuration may be such that only the CLI resource #2 508 is on the corresponding combination, thus, the WTRU selects the CLI resource #2, 508.

In an example, the WTRU may determine that none of the resources is of the same duplexing/SBFD configuration combination as the associated duplexing/SBFD configuration combination of the measurement and reporting configuration. The WTRU determines that no resource is suitable and may later skip the measurement.

In another example, the WTRU may determine that more than one of the resources is of the same duplexing/SBFD configuration combination as the associated duplexing/SBFD configuration combination of the measurement and reporting configuration. The WTRU may selects one of the corresponding resources for measurement, based on received/(pre)configured priority rules, e.g.: based on received the resource order, e.g., the WTRU selects the first one in an ordered list of resource that is satisfying, based on resource ID, e.g., the WTRU selects the resource with lowest ID; and based on resource time position, e.g., select the resource that has the earliest time symbol.

In an example, if the WTRU received the configuration that the measurement and reporting supports measurement on multiple resources, the WTRU may select up to the configured maximum number of measurement resources, e.g., following above-mentioned priority rules to up to the maximum number of resources. The WTRU may be configure to perform measurement result averaging across the multiple resources that are of the same duplexing/SBFD. The measurement result averaging may be associated with a weighted-averaging function where the WTRU may receive configuration of one or more parameters for the weighted-averaging function, e.g., a time-domain moving-average function. In an example, the time-domain moving-average function may be prioritizing more recent (in time domain) measurement resource, where a larger coefficient value may be multiplied to the more recent measurement to be averaged with a second measurement (being multiplied with a smaller coefficient value) prior to the more recent measurement.

In one an example embodiment, the WTRU may receive a configuration of a measurement and reporting where the measurement resources are individually associated to a duplexing/SBFD configuration combination. The WTRU may determine, among the configured measurement resources, if any of the determined type of CLI of the resource corresponds to the received associated type of CLI for that resource.

In an example, the WTRU determines that one of the resources is of the same duplexing/SBFD configuration combination as the configured associated duplexing/SBFD configuration combination. The WTRU selects that one resource for measurement.

In another example, the WTRU may determine that none of the resources is of the same CLI type as the configured associated duplexing/SBFD configuration combination. The WTRU may determine that no resource is suitable and may later skip the measurement.

In an example, the WTRU may determine that more than one of the resources is of the same duplexing/SBFD configuration combination as the configured associated duplexing/SBFD configuration combination. The WTRU may select one of the corresponding resources for measurement, based on received/(pre)configured priority rules, e.g.: based on received the resource order, e.g., the WTRU selects the first one in an ordered list of resource that is satisfying; based on resource ID, e.g., the WTRU selects the resource with lowest ID; or based on resource time position, e.g., select the resource that has the earliest time symbol.

In an example embodiment, the WTRU may trigger the (re)determination of the CLI measurement resources to use for the configured CLI measurements, upon reception of any or more of: a (re)configuration of the serving cell duplexing/SBFD configuration, e.g., via SIB, MAC, RRC or DCI indication from the serving cell; a (re)configuration of another cell's duplexing/SBFD configuration, e.g., via SIB, MAC, RRC or DCI indication from the serving cell; a (re)configuration of the CLI measurement and reporting configuration, e.g., via MAC, RRC or DCI indication from the serving cell, e.g., if the resources and/or the association with CLI type or duplexing/SBFD configuration are (re)configured; and a trigger to perform CLI measurement, e.g., via RRC, MAC or DCI, indicating the CLI measurement and reporting configuration. In one example, for a periodic measurement and reporting, e.g., received by RRC (re)configuration, the WTRU triggers the determination a first time at the reception of the configuration. In another one example, for a semi-persistent measurement and reporting, the WTRU may trigger the determination at each reception of an activation indication (e.g., through MAC, DCI or RRC), and in one example, for an aperiodic measurement and reporting, the WTRU may trigger the determination at each reception of an measurement command/trigger (e.g., through MAC, DCI or RRC).

In an example embodiment, the WTRU performs the CLI measurement on the selected/determined resource(s) and reports the corresponding measurements to the network. In another example, the WTRU performs one or multiple measurement(s), out of the set/pool of configured measurement resources to measure the CLI, e.g., measuring (L1-)CLI-RSSI or (L1-)SRS-RSRP, based on the resource(s) determined in the previous step.

In an example, the report may include one or more of the following: the measurement values. The WTRU may report the performed measurements with the corresponding values/quantities, e.g., (L1-)CLI-RSSI or (L1-)SRS-RSRP, based on the received measurement and reporting configuration, and the WTRU may report one or more measurements, based on the configured maximum number of report and based on the selected resources, the selected resources. The WTRU may report the selected resources on which it performs the measurements, to indicate to the network which resources the measurement corresponds to: in one example, the WTRU reports the resource ID of the selected/measured measurement resource(s); in another example, the WTRU reports the index/indices of the resource in the set/pool of measurement resources; and in one example, the WTRU reports the resource(s) (e.g., resource elements, time/frequency information of the resources).

The WTRU may report the type of CLI (e.g., one of Co-channel CLI, SBFD leakage CLI, Inter-carrier CLI leakage) that corresponds to the measurement resource(s). In particular the WTRU may report in the case where the determined the CLI type based on information that are not received by the serving cell (e.g., received from another cell). The CLI type may be reported individually for each resource, e.g. if the different resources are associated with a different CLI type or the CLI type may be reported for the set of resource measured for that CLI measurement and reporting.

The WTRU may report the duplexing/SBFD configuration of the other cell, e.g., when the WTRU did not receive the configuration from the serving cell (e.g., via monitoring SIB/PDCCH of other cells). For example, the WTRU may report the time pattern of the other cell, used to determine the CLI type of the different resources, e.g., similar to the received TDD-UL-DL-ConfigCommon or tdd-UL-DL-Configuration for SBFD. In another example, the WTRU may report the resources (time and/or frequency positions) on which the other cell is configured with UL transmission, e.g., to only indicate the positions of the resources with potential CLI.

In one option, the WTRU may send the report to the network, e.g., using the reporting resource configuration received. The report may be sent, for example, using the configured reporting resources, or using, e.g., MAC CE, RRC or PHY layer indications. The report may be sent jointly for all the measured resources of the CLI measurement and reporting configuration. In the case of multiple measurements performed, the WTRU may transmit a single report including multiple measurements. The report may be sent separately the measured resources of the CLI measurement and reporting configuration. In the case of multiple measurements performed, the WTRU may transmit the measurement report individually. Joint/bundled with other report. The WTRU may transmit the report jointly with other reports, such as other measurement reports (e.g., other CLI/CSI reports), if the resources are enough to include multiple reports.

Reported information may be split in different reports. For example, the WTRU may report the CLI types of the measurement resource and/or the duplexing configuration of other cells in a first report, and the measurement in other report(s). The WTRU may use different transmission resources or reporting methods to report different information. For example, the WTRU may use RRC or MAC level reporting to indicate the CLI type of the resources, and use the CLI/CSI reporting resources for measurement reports. The WTRU may report the CLI types of the measurement resource and/or the duplexing configuration of other cells in a first report that is transmitted only when the WTRU received/determine a change in the configuration, while the WTRU may report multiple instance of measurements over time (e.g., based on periodic, aperiodic, semi-periodic reporting configuration and triggers).

In another example, the WTRU may not perform (e.g., skip) the measurement, e.g., when no suitable resource is found in the set of configured resources. The WTRU may report to the network, e.g., via MAC layer or PHY layer indication that the WTRU skipped the measurement. In one example, the WTRU uses the measurement report with an empty content.

In another example, the WTRU uses the measurement report with an indication that the measurement was not performed. The WTRU may indicate the reason why it skipped the measurement, e.g., indicating a mismatch of CLI type or duplexing/SBFD configuration between the measurement configuration and the dynamic duplexing/SBFD configuration of the cell(s). The WTRU may include the specific configuration on the measurement resource, e.g., the duplexing/SBFD configuration or configuration combination at the time of the resource. In another example, the WTRU may report a repetition of the previous measurement. In another example, the WTRU may report a partial measurement, i.e., if the measurement was performed on multiple resources (e.g., when averaged/filtered over time), the WTRU may report the measurement determined without the skipped measurement. The WTRU may include an indication of the skipped measurements. In yet another example, the WTRU may not transmit any report for that measurement.

The following description and aspects may be considered in replacement, complement or addition with the with other aspects described herein. In an example embodiment, the WTRU may receive the (pre)configuration including semi-persistent CLI measurement and reporting conditioned to CLI type or duplexing configurations. The WTRU may then activate or deactivate the measurement and reporting based on the received indication about the duplexing configuration of its cell or other cells.

A WTRU may receive a (pre)configuration to perform measurement and reporting of the CLI (e.g., via RRC configuration), including the associated measurement resource(s), where, for example, the measurement and reporting are configured to be semi-persistent, and configured with a (de)activation trigger based on the reception/determination of the configuration or update of the duplexing configuration of the serving cell and/or another cell.

In one example, the activation trigger is receiving a (re)configuration that the serving cell is configured with one or more SBFD patterns (e.g., DU, UD, DUD, DUD) and deactivation if receiving a (re)configuration otherwise.

In another example, the activation trigger is receiving a (re)configuration that the serving cell is configured with SBFD, where the symbols/slots of the measurement resource are on symbols/slots configured with an UL sub-band and deactivation if receiving a (re)configuration otherwise.

In another example, the activation trigger is receiving a (re)configuration that the serving cell is configured with SBFD/duplexing configuration and/or another cell's duplexing/SBFD configuration that follows one or more combinations, for example, when: the WTRU's serving cell is ‘DU’ while the other cell is ‘UD’ or ‘Uplink’; the WTRU's serving cell is ‘UD’ while the other cell is ‘DU’ or ‘Uplink’; the WTRU's serving cell is ‘DUD’ while the other cell is ‘DU’, ‘UD’, ‘UDU’, or ‘Uplink’; the WTRU's serving cell is ‘UDU’ while the other cell is ‘DU’, ‘UD’, ‘DUD’, or ‘Uplink’; the WTRU's serving cell is ‘DL’ while the other cell is ‘DU’, ‘UD’, ‘DUD’, ‘UDU’ or ‘Uplink’; the WTRU's serving cell is ‘DL’ and a frequency adjacent cell is configured with an UL sub-band (or as an UL symbol/slot) on the common frequency edge; and a deactivation trigger may be considered when the WTRU receives a configuration not included in the combinations.

In an example, the activation trigger is receiving a (re)configuration of the serving cell and/or other cell duplexing/SBFD configuration where the frequency distance between the UL (sub)band of the other cell and the DL (sub)band of the serving cell is below a threshold or that the UL and DL(sub)bands are overlapping. A deactivation trigger may be considered when the WTRU receives a (re)configuration indicating that the UL and DL sub-bands are not (or no longer) overlapping or that the frequency distance is not (no longer) below a threshold.

In another example, the activation trigger is receiving a (re)configuration of the duplexing/SBFD configuration of the serving cell and/or other cell, (indirectly) indicating that the CLI type expected on the measurement is one of the configure CLI type(s) associated with the measurement (e.g., Co-channel CLI, SBFD leakage CLI, Inter-carrier CLI leakage). The (de)activation trigger is receiving a (re)configuration indicating that the CLI type is not/no longer the one associated with the measurement.

In an example embodiment, the WTRU receives the (re)configuration of the duplexing/SBFD configuration of its serving cell and/or of another cell. After reception of the (re)configuration, e.g., through RRC, MAC or DCI indication, the WTRU may evaluate whether the (de)activations of the measurements are triggered.

For example, the WTRU receives the duplexing/SBFD configuration(s) of its serving cell and/or another cell, then determines the CLI type based on the received configuration and the association between duplexing/SBFD cells, then determines whether the received configuration triggers the activation or deactivation of the semi-persistent measurement and report. The determination of CLI type and how to associate duplexing/SBFD patterns to CLI type are as described in the foregoing.

In one example, the WTRU determines that the received (re)configuration leads to the measurement resource being on symbol/slots experiencing a co-channel CLI and SBFD leakage CLI, and the measurement is associated co-channel CLI or SBFD leakage CLI, then the WTRU activates the measurement and report. (if the measurement and report was already activated, no change is needed). In another example, the WTRU determines that the received (re)configuration leads to the measurement resource being on symbol/slots experiencing a co-channel CLI and SBFD leakage CLI, and the measurement is associated with Inter-carrier CLI leakage, then the WTRU deactivates the measurement and report. (if the measurement and report was already deactivated, no change is needed).

For example, the WTRU may receive the indication that the serving cell is (re)configured on the symbol/slot of the measurement with a SBFD pattern associated with the measurement configuration, an UL sub-band, or evaluating the frequency distance between the measurement resource and the UL sub-band being lower than the threshold, then the WTRU may activate the measurement. As another example, the WTRU may receive the indication that the serving cell is (re)configured on the symbol/slot of the measurement with DL while the measurement configuration is associated with a SBFD pattern, or if the frequency distance between the measurement resource and the UL sub-band is beyond a threshold, then the WTRU may deactivate the measurement.

For example, the WTRU may receive the indication that the serving cell and/or another cell is (re)configured to any of the combination or frequency distance associated with the measurement (based on the received configuration of the duplexing combinations), the WTRU may activate the measurement and reporting. Otherwise, the WTRU may deactivate the measurement and reporting.

In another example, the WTRU may receive the indication that the neighboring cell is (re)configured so that a previous ‘DL’ or ‘DU’ symbol/slot is now ‘UL’ or ‘UD’, while the serving cell is ‘DU’, thus generating a co-channel CLI on the measurement resource. The WTRU may then activate the measurement and reporting if configured with these combinations.

In another example, the WTRU may receive the indication that the neighboring cell is (re)configured so that a previous ‘UL’ or ‘UD’ symbol/slot is now ‘DL’ or ‘DU’, while the serving cell is ‘DU’, thus no longer generating a co-channel CLI on the measurement resource. The WTRU may then deactivate the measurement and reporting if configured with these combinations.

In an example embodiment, the WTRU activating of the semi-persistent measurement of a received measurement and reporting configuration prepares/(re)configures itself to perform the measurement on the corresponding configured measurement resources, for example, measuring (L1-)CLI-RSSI, (L1-)SRS-RSRP, etc. according to the configured periodicity. The WTRU may further report the measurement as configured by the network, e.g., using the corresponding resources.

In example embodiment, the WTRU deactivating of the semi-persistent measurement of a received measurement and reporting configuration prepares/(re)configures itself to stop/skip the measurement on the corresponding configured measurement resources, and may no longer report the corresponding measurements.

In example embodiment, the WTRU may report to the network the (de)activation of the semi-persistent configured measurement and reporting, e.g., in the case where the WTRU determines that the conditions/(de)activation triggers associated with the measurement and reporting based on information that the WTRU did not received from the serving cell. For instance, if the WTRU receives the duplexing/SBFD configuration of another cell from that cell, then the WTRU may send a report to the network indicating the (de)activation.

The report may include at least one of: (de)activation indication, corresponding measurement and reporting ID, other cell ID, other cell duplexing/SBFD configuration, CLI type on the measurement resources, etc. The report may be sent using RRC, MAC or PHY-level UL indication The report may be sent using the configured resource for the reporting, e.g., instead of a measurement report. In one example, the WTRU may send a value (pre)configured by the network that can be recognized as a (de)activation indication, e.g., using a reserved value, a zero or infinite value, etc.

In one alternative embodiment, the WTRU may be configured with a periodic measurement and reporting configuration. The WTRU may report to the network an indication to (re)configure, or a request to (re)configure the measurement and reporting based on the received information. Similarly as in the previous description, for example, if the WTRU receives the duplexing/SBFD configuration of another cell from that cell, then the WTRU may send the (re)configuration or (re)configuration request.

The indication may include at least one of: (de)activation indication, corresponding measurement and reporting ID, other cell ID, other cell duplexing/SBFD configuration, CLI type on the measurement resources, etc. The indication may be sent using RRC, MAC or PHY-level UL indication The indication may be sent using the configured resource for the reporting, e.g., instead of a measurement report. In one example, the WTRU may send a value (pre)configured by the network that can be recognized as a (de)activation indication, e.g., using a reserved value, a zero or infinite value, etc.

The WTRU may receive different measurement and reporting configuration for different CLI types, and, based on the CLI type of the measurement resource, apply the corresponding configuration. The WTRU may be indicated with the CLI type for the measurement and/or resource (simple application of configuration) The WTRU may determine the CLI type of the measurement based on the resource and duplexing config, then apply the corresponding configuration. Different configurations may include: different measurement (RSRP, RSSI, SINR, L1 vs L3, . . . ); different thresholds for triggers/reports; and regrouping same CLI type measurements for averaging.

In an example embodiment, a WTRU may be configured to measure CSI for Interference Management (CSI-IM. The WTRU may receive a (pre)configuration for a serving cell including: a duplexing/SBFD configuration for each time resource (slot and symbol), including the duplexing direction and/or SBFD pattern (e.g., DU, UD, DUD) and the frequency position and size of the UL and DL sub-bands, a CLI measurement and reporting configuration, e.g., periodic (L1-)CLI-RSSI, including a CLI resources (time, frequency), and a set of measurement/reporting configuration for different types of CLI measurements, for example, a first threshold for co-channel CLI measurement and a second threshold for SBFD leakage CLI measurement, and a first reporting quantity (CLI RSSI) for co-channel CLI measurements and a second reporting quantity (L1-CLI-RSSI) for SBFD leakage measurement.

The WTRU may receive an indication (e.g., via MAC or DCI) of the configuration of the duplexing direction and/or SBFD pattern of another cell (e.g., a neighboring cell-using cell ID). The WTRU may determine the type of CLI measurement of the configured CLI measurement based on the and the duplexing/SBFD configuration of the cells corresponding to the measurement resource, for example, the WTRU may determine that a measurement resource corresponds to a co-channel CLI measurement based on overlapping UL (from the other cell) and DL (from serving cell), and if no CLI expected on that resource, the WTRU may skip the measurement.

In addition, the WTRU may report the CLI measurement, including, e.g., the measurement result, the measurement/reporting configuration. In a case where the WTRU did not perform a CLI measurement, the WTRU may skip the report, report the remaining measurements (e.g., when using L3 averaging), and send an indication that it did not perform the measurement based on configuration.

In an embodiment, the WTRU may receive a configuration for a set of configurations (e.g., measurement quantity, thresholds, etc.) for each type of measurements (e.g. CLI types), and a (CLI) measurement and reporting configuration associated with one CLI type. The WTRU may determine the measurement and reporting configuration for that measurement based on the CLI type and the corresponding received configuration. The WTRU may perform the measurement and reporting the measurement according to the received measurement and reporting configuration and the CLI-type specific configuration.

In an example embodiment, the WTRU may receive a configuration for a set of configurations (e.g., measurement quantity, thresholds, etc.) for each type of measurements (e.g. CLI types), a (CLI) measurement and reporting configuration, and the duplexing/SBFD configuration of one or more cell(s). The WTRU may determine the CLI type of the measurement resources based on the received duplexing/SBFD configuration of one or more cell(s). The WTRU may perform the measurement and reporting the measurement according to the received measurement and reporting configuration and the CLI-type specific configuration based on the determined CLI type.

In an example embodiment, (in addition to the other received configuration described previously), the WTRU may receive multiple sets of configurations related to measurement and reporting, each set being associated with a CLI type. The WTRU may receive the configuration using RRC (re)configuration and/or using MAC/DCI indications. In one example, the sets of configurations may include one or more of: measurement quantity, thresholds, sub-band vs wideband measurement and reporting, and reporting configuration.

Measurement quantity may, for example, include, a first configuration associated with a CLI type of SBFD CLI leakage may be configured with measurement and reporting using L1-CLI-RSSI, while a second configuration associated with inter-carrier CLI leakage may be configure with CLI-RSSI, or a first configuration associated with a CLI type of SBFD CLI leakage may be configured with measurement and reporting using (L1-)CLI-RSSI, while a second configuration associated with co-channel CLI may be configured with measurement and reporting using (L1-)SRS-RSRP.

Thresholds may, for example, include, a first configuration associated with a CLI type of SBFD CLI leakage or inter-carrier leakage may be configured with a first threshold value, e.g., for reporting or triggering CLI mitigation procedures, while a second configuration associated with co-channel CLI may be configure with a second threshold value, e.g., for reporting or triggering CLI mitigation procedures.

Sub-band vs wideband measurement and reporting may, for example, include, a first configuration associated with a CLI type of SBFD CLI leakage or inter-carrier CLI leakage may be configured with measurement and reporting using sub-band reporting, while a second configuration associated with co-channel CLI may be configured with wideband (non-sub-band) measurement and reporting.

Reporting configuration may, for example, include, a first configuration associated with a CLI type of SBFD CLI leakage or inter-carrier leakage may be configured with a first reporting periodicity, while a second configuration associated with co-channel CLI may be configure with a second reporting periodicity, or a first configuration associated with a CLI type of SBFD CLI leakage or inter-carrier leakage may be configured with a first reporting priority, while a second configuration associated with co-channel CLI may be configure with a second reporting priority. The priority may be used to determine which measurement(s) to include in a report.

In an example embodiment, the WTRU may determine the CLI type of the measurement/measurement resource based the cell's and/or other cell's configuration, e.g., based on their duplexing/SBFD configurations. The WTRU may first receive its serving cell configuration, and may receive another cell's configuration. These configurations may be updated dynamically or semi-statically. When the WTRU receive these, the WTRU may determine the CLI type it can expect on the measurement resource(s) received in the measurement configuration (see [WTRU determining the CLI Type of the measurement resources based on duplexing/SBFD configuration]). The WTRU may determine the CLI type of the configured measurement based on its resource(s), or the WTRU may determine the CLI type of each the configured measurement resources individually.

In another example embodiment, the WTRU may receive a configuration where the measurement and report include the associated CLI type expected for the measurement and report. In one example, the CLI type may be associated to one/each measurement resource(s) or it may be associated with one CLI type for the measurement itself (e.g., all the included measurement resources).

In an example embodiment, the WTRU may determine the measurement and reporting configuration based on both the measurement and reporting configuration and the associated/determined CLI type-specific configuration. The WTRU may use the CLI-type specific configuration in complement or in replacement with the original measurement configuration. In one example, the WTRU may receive a configuration for a CLI measurement and reporting with a measurement resource using a first set of configurations (e.g., reporting quantity, thresholds, etc.), and the WTRU determines that, based on the duplexing/SBFD configuration, the resource may be subject to SBFD leakage CLI. The WTRU may, for example, use the quantity and/or threshold, and/or sub-band configuration of the received set of measurement configurations for SBFD leakage CLI, or use the reporting periodicity, reporting resource or threshold trigger to report of the received set of measurement configurations for SBFD leakage CLI.

The WTRU may also report the configuration used to perform the measurement and reporting, in particular in the case where the WTRU determine the CLI type based on information not received from the serving cell. In one example, the WTRU may report the CLI type of the measurement resource(s) or of the measurement. In another example, the WTRU may report the duplexing/SBFD configuration of the other cell on the measurement resource(s). In another example, the WTRU may report the index of CLI-Type-specific configuration used for the measurement and reporting. In another example, the WTRU may report previous information jointly with a measurement report, e.g., for each resource separately or for the measurement. In another example, the WTRU may report previous information or as a separate information reporting (e.g., using MAC, PHY or RRC level signaling). The WTRU may be trigger to report this based on receiving an information from another cell or based on determining that the CLI-type or measurement/reporting configuration has been updated.

A WTRU may be configured with a set of SRS resources for transmission associated with a CLI type or duplexing/SBFD configurations, and the WTRU may determine which of the SRS resource(s) to use for SRS transmission based on the SBFD configuration of the cell and neighboring cells or the CLI type that the WTRU may receive from or generate to WTRUs of other cells. The WTRU may further be configured and use CLI-type specific transmission parameter for the SRS transmissions, based on the determined CLI type.

In an example embodiment, a WTRU may receive a (pre)configuration for a serving cell including: a duplexing/SBFD configuration for each time resource (slot and symbol), including the duplexing direction and/or SBFD pattern (e.g., DU, UD, DUD) and the frequency position and size of the UL and DL sub-bands, a set of SRS resources for transmission, the set or each resource being associated with a CLI type or a duplexing/SBFD configuration or duplexing/SBFD configuration combination with another cell (e.g., based on cell ID), and a CLI type-specific sets of SRS transmission configurations, including, for example, transmit power parameters, beam parameters, time offsets, etc. The WTRU may receive an indication (e.g., via MAC or DCI) of the configuration of the duplexing direction and/or SBFD pattern of another cell (e.g., a neighboring cell-using cell ID). The WTRU may be triggered/indicated to perform the SRS transmission using the SRS resource set, e.g., by DCI indication, semi-persistent MAC CE activation or periodic transmission.

The WTRU may determine a CLI type corresponding to the CLI other WTRUs may experience on the time resources of the SRS resource(s) based on the duplexing/SBFD configuration of the serving cell and/or the other cell. Examples include: a SRS resource in the UL sub-band of a SBFD symbol in the serving cell is of type “SBFD CLI-leakage,” a SRS resource in a UL (sub)-band of the serving cell and corresponding to an DL (sub)band on the other (neighboring) cell is of type “co-channel CLI,” and. a SRS resource in a UL (sub)band of the serving cell and frequency-adjacent to another cell/carrier configured in DL is of type “inter-carrier CLI leakage.”

The WTRU may determine the SRS resource(s) for transmission based on the determined CLI type. For example, the WTRU may select, if any, the SRS resources whose determined CLI type corresponds to the received configuration of the SRS resource(s). In a scenario where multiple resources satisfy the condition, the WTRU may select one resource based on priority rules (e.g., based on the ordered list, based on UE ID, cell ID etc.). In a scenario where none of resources satisfy the condition, the WTRU may skip the SRS transmission. In addition, the WTRU may transmit SRS on the determined SRS resource(s) using the corresponding CLI-type specific transmission parameters, for example, using CLI-type specific power control parameters.

In an example embodiment, the WTRU receives a SRS transmission configuration including a set of SRS resources. In one example, the configuration may include an association between the SRS resource(s) or the SRS resource set and a duplexing/SBFD configuration of the serving cell, or the combination of duplexing/SBFD configuration between the serving cell and another cell, e.g., indicated via cell ID or frequency indication. For example, one or more resource(s) may be associated to the serving cell being configured with an SBFD symbol on the time of the resource, e.g., a DU, UD, DUD and/or UDU configuration. In another example, one or more resource(s) may be associated to the serving cell being configured with an SBFD symbol on the time of the resource, where the frequency distance between the DL sub-band and the UL sub-band or the SRS resource is not larger than a threshold. In another example, one or more resource(s) may be associated to the serving cell being configured with an UL (sub)band and corresponding to an DL (sub)band on another (neighboring) cell. In another example, one or more resource(s) may be associated to the serving cell being configured with an UL (sub)band and the frequency distance to a DL (sub)band on another (e.g., inter-carrier) cell is no larger than a threshold.

In another example, the configuration may include an association between the SRS resource(s) or the SRS resource set and a CLI type with one or more cells. This may include: one or more resource(s) may be associated to the CLI-type SBFD leakage CLI; one or more resource(s) may be associated to the CLI-type co-channel CLI; one or more resource(s) may be associated to the CLI-type inter-carrier CLI leakage, or the CLI-type associated with the SRS resource may be indicated using the usage field in the SRS configuration.

The WTRU may be triggered or indicated to perform an SRS transmission (e.g., based on the received configuration from RRC). For example, for SRS transmissions using periodic configuration, on the time of the period (e.g. based on timer); for SRS transmissions using semi-persistent configurations, based on MAC activation indication and/or periodicity of the semi-persistent transmission; or SRS transmissions using aperiodic transmission, based on PHY-level command (DCI).

In an example embodiment, the WTRU may determine a CLI type corresponding to the CLI other WTRUs may experience on the time resources of the SRS resource(s) based on the duplexing/SBFD configuration of the serving cell and/or the other cell(s). Note that although several aspects may be common and imported from the foregoing description, a difference here is that the WTRU may use the CLI type of another WTRUs, i.e., considering another WTRUs point of view of the CLI. Compared to the configuration patterns and/or combinations described in previous sections, the WTRU here may invert the serving cell and other cell to determine the CLI type.

For example: an SRS transmission resource may be considered of type Co-channel CLI if it is in a configured UL (sub)band and any of: the WTRU's serving cell is ‘DU’ while a neighboring cell is ‘UD’ or ‘Downlink,’ the WTRU's serving cell is ‘UD’ while a neighboring cell is ‘DU’ or ‘Downlink,’ the WTRU's serving cell is ‘DUD’ while a neighboring cell is ‘DU’, ‘UD’, ‘UDU’, or ‘Downlink,’ the WTRU's serving cell is ‘UDU’ while a neighboring cell is ‘DU’, ‘UD’, ‘DUD’, or ‘Downlink,’ the WTRU's serving cell is ‘UL’ while a neighboring cell is ‘DU’, ‘UD’, ‘DUD’, ‘UDU’ or ‘Downlink,’ or the UL sub-band of the serving cell overlaps in frequency with the DL sub-band of a neighboring cell; and an SRS transmission resource may be considered of type Inter-carrier CLI leakage if it is in a configured UL (sub)band and any of: the WTRU's serving cell is ‘UL’ and a frequency adjacent cell is configured with an DL sub-band (or as an DL symbol/slot) on the common frequency edge; the WTRU's serving cell is ‘UD’, ‘DU’, or ‘UDU’ and a frequency adjacent cell is configured with an DL sub-band (or as an DL symbol/slot) on the frequency edge adjacent to the UL sub-band; and/or when the frequency distance between the other cell DL sub-band and the UL sub-band of the serving cell is below a (pre)configured threshold

In one solution, the WTRU may select the SRS resource(s) for transmission based on the determined CLI type and the CLI-type associated with the SRS resource(s) received in the configuration. This step may be similar as described in 4.2.2 but where the WTRU selects SRS resource(s) for transmissions instead of measurement resources. For instance, the WTRU may select: a SRS resource associated with the type “SBFD CLI-leakage” because the serving cell is configured as a SBFD symbol on the time of the resource, a SRS resource associated with the type “co-channel CLI” because the serving cell is configured with a UL (sub)band and corresponds to an DL (sub)band on the other (neighboring) cell, and a SRS resource associated with the type “inter-carrier CLI leakage” because the serving cell is configured with an UL (sub)band and a frequency-adjacent cell/carrier is configured in DL.

In a corresponding embodiment, the WTRU may receive a configuration indicating, for each CLI type (or for each SBFD/duplexing configuration combination), and an associated set of SRS transmission parameters. The transmission parameters may include: transmission power parameters, beams, time offsets, etc. Such difference in transmission parameter would help the WTRU to transmit according to the purpose of the SRS, e.g., targeting WTRUs in its own cell or in another cell. The CLI-type specific transmission parameters may also be different from the SRS transmission for regular UL RS measurement from the network.

For example: a first CLI type may (e.g., SBFD leakage CLI) be associated with a first transmit power control loop parameter while a second CLI type (co-channel CLI) may be associated with a second transmit power control loop parameter; a first CLI type may (e.g., SBFD leakage CLI) be associated with a first transmission beam (e.g., TCI state, QCL indication, associated RX/TX spatial filter) while a second CLI type (co-channel CLI) may be associated with a second transmission beam (e.g., TCI state, QCL indication, associated RX/TX spatial filter); a first CLI type may (e.g., SBFD leakage CLI) be associated with a first time alignment/offset parameter while a second CLI type (co-channel CLI) may be associated with a second time alignment/offset (which may even be other cell specific); a first set of transmission parameters are configured for SRS transmission targeting CLI measurements, while a second set of transmission parameters are configured for SRS transmission targeting UL measurement from the network; and a first set of transmission parameters are configured for SRS transmission associated with a first duplexing/SBFD configuration of the serving and/or other cell, while a second set of transmission parameters are configured for SRS transmission associated with a second duplexing/SBFD configuration of the serving and/or other cell.

In an example embodiment, the WTRU may determine the SRS transmission parameters based on the determined/indicated CLI type and the received CLI-type-specific transmission parameters and/or the duplexing/SBFD configuration of the serving and other cell. The WTRU may then perform the SRS transmission on the selected/determined SRS resource(s), if any, and using the determined transmission parameters specific to the CLI type and/or duplexing/SBFD configuration. The WTRU may report to the network the SRS resources used, the duplexing/SBFD configuration of the other cell and/or the CLI type of the SRS transmission resources.

In an example embodiment, a WTRU may be configured to: receives a (pre)configuration for a serving cell including: the duplexing/SBFD configuration for each time resource (slot and symbol), including the duplexing direction and/or SBFD pattern (e.g., DU, UD, DUD) and the frequency position and size of the UL and DL sub-bands, and a CLI measurement and reporting configuration, for example, a periodic (L1-)CLI-RSSI, including: one or more CLI measurement resources (time, frequency), as an ordered list, for example, a CLI type, e.g., one of: SBFD leakage CLI, co-channel CLI, inter-carrier CLI leakage, and optionally, the cell ID of a second or neighbor cell.

The WTRU may be configured to: receive an indication (e.g., via MAC or DCI) of the configuration of the duplexing direction and/or SBFD pattern of another cell (e.g., a neighboring cell—using cell ID), and determine a CLI type for the CLI measurement resources based on the duplexing/SBFD configuration of the serving cell and/or the other cell. This may for example, be a CLI measurement resource in the DL sub-band of a SBFD symbol in the serving cell is of type “SBFD CLI-leakage,” a CLI measurement resource in a DL (sub)band of the serving cell and corresponding to an UL (sub)band on the other (neighboring) cell is of type “co-channel CLI”, or a CLI measurement resource in a DL (sub)band of the serving cell and frequency-adjacent to another cell/carrier configured in UL is of type “inter-carrier CLI leakage.”

The WTRU may be configured to determine the CLI measurement resource to perform the CLI measurement on, based on the determined CLI type. The WTRU may, for example, select, if any, the resources whose determined CLI type corresponds to the received configuration of the CLI measurement and report. If multiple resources satisfy the condition, the WTRU may select one resource based on priority rules (e.g., based on the ordered list, based on UE ID, cell ID etc.). If none of resources satisfy the CLI condition, the WTRU may skip the measurement.

The WTRU may be configured to perform the CLI measurement on determined CLI measurement resource. If no resource is configured on time resources where CLI may be generated, the UE may skip the measurement. The WTRU may report the CLI measurement, including, e.g., the measurement result, the resource selected, the determined CLI type and/or corresponding SBFD configuration of the cells. If the WTRU did not perform the CLI measurement, the WTRU may skip the report. The WTRU may report the remaining measurements (e.g., when using L3 averaging) and may indicate that the WTRU did not perform the measurement based on configuration.

In an example embodiment, a WTRU may activate/deactivate measurements based on SBFD configuration. A WTRU may be configured to receive a (pre)configuration for a serving cell including: the duplexing/SBFD configuration for each time resource (slot and symbol), including the duplexing direction and/or SBFD pattern (e.g., DU, UD, DUD) and the frequency position and size of the UL and DL sub-bands and a CLI measurement and reporting configuration, e.g., semi-persistent (L1-)CLI-RSSI, including: a CLI type, e.g., one of: SBFD leakage CLI, co-channel CLI, inter-carrier CLI leakage, or an association/condition to a the duplexing/SBFD pattern of one or more cell(s), e.g., the serving cell and a neighboring cell using the cell ID.

The WTRU may be configured to receive an indication (e.g., via RRC, MAC or DCI) of the configuration of the duplexing direction and/or SBFD pattern of another cell (e.g., a neighboring cell—using cell ID). The WTRU may be configured to activate or deactivate the CLI measurement based on the configuration of the duplexing direction and/or SBFD pattern of the cell(s). For example: the WTRU may activate the semi-persistent measurement based on receiving indication that the corresponding cell(s) is configured with a pattern generating the associated CLI type on the measurement resource, or the WTRU may deactivate the semi-persistent measurement based on receiving indication that the corresponding cell is not configured with a duplexing/SBFD pattern combination associated with the measurement. When the semi-persistent measurement is activated, the WTRU performs the CLI measurement on configured CLI measurement resource. The WTRU may be configured to report the CLI measurement, including, e.g., the measurement result, the resource selected, the corresponding cell and/or cell's configuration.

In an example embodiment, a WTRU may employ different behaviors based on measurement type. For example, a WTRU may be configured to receive a (pre)configuration for a serving cell including: the duplexing/SBFD configuration for each time resource (slot and symbol), including the duplexing direction and/or SBFD pattern (e.g., DU, UD, DUD) and the frequency position and size of the UL and DL sub-bands, a CLI measurement and reporting configuration, e.g., periodic (L1-)CLI-RSSI, including a CLI resources (time, frequency), and a set of measurement/reporting configuration for different types of CLI measurements, for example, a first threshold for co-channel CLI measurement and a second threshold for SBFD leakage CLI measurement, or a first reporting quantity (CLI RSSI) for co-channel CLI measurements and a second reporting quantity (L1-CLI-RSSI) for SBFD leakage measurement.

The WTRU may receive an indication (e.g., via MAC or DCI) of the configuration of the duplexing direction and/or SBFD pattern of another cell (e.g., a neighboring cell—using cell ID), and determine the type of CLI measurement of the configured CLI measurement based on the and the duplexing/SBFD configuration of the cells corresponding to the measurement resource, for example, the WTRU may determine that measurement resource corresponds to a co-channel CLI measurement based on overlapping UL (from the other cell) and DL (from serving cell), or if no CLI expected on that resources, the WTRU may skip the measurement.

The WTRU may perform the CLI measurement on determined resource, using the set of measurement/reporting configuration based on the determined CLI type. If no resource is configured on time resources where CLI may be generated, the WTRU may skip the measurement. The WTRU may report the CLI measurement, including, e.g., the measurement result, the measurement/reporting configuration. If the WTRU did not perform measurement, the WTRU may skip the report, report the remaining measurements (e.g., when using L3 averaging), and send an indication that the WTRU did not perform the measurement based on configuration.

In an example embodiment, a WTRU may be configured to receive a (pre)configuration for a serving cell including: the duplexing/SBFD configuration for each time resource (slot and symbol), including the duplexing direction and/or SBFD pattern (e.g., DU, UD, DUD) and the frequency position and size of the UL and DL sub-bands, a set of SRS resources for transmission, the set or each resource being associated with a CLI type or a duplexing/SBFD configuration or duplexing/SBFD configuration combination with another cell (e.g., based on cell ID), and CLI type-specific sets of SRS transmission configurations, including, for example, transmit power parameters, beam parameters, time offsets, etc.

The WTRU may receive an indication (e.g., via MAC or DCI) of the configuration of the duplexing direction and/or SBFD pattern of another cell (e.g., a neighboring cell - using cell ID), perform the SRS transmission using the SRS resource set, e.g., by DCI indication, semi-persistent MAC CE activation or periodic transmission according to a trigger or indication, and determine a CLI type corresponding to the CLI other WTRUs may experience on the time resources of the SRS resource(s) based on the duplexing/SBFD configuration of the serving cell and/or the other cell, for example: a SRS resource in the UL sub-band of a SBFD symbol in the serving cell is of type “SBFD CLI-leakage,” a SRS resource in a UL (sub)band of the serving cell and corresponding to an DL (sub)band on the other (neighboring) cell is of type “co-channel CLI,” or a SRS resource in a UL (sub)band of the serving cell and frequency-adjacent to another cell/carrier configured in DL is of type “inter-carrier CLI leakage.”

The WTRU may determine the SRS resource(s) for transmission based on the determined CLI type. For example, the WTRU may select, if any, the SRS resources whose determined CLI type corresponds to the received configuration of the SRS resource(s). If multiple resources satisfy the condition, select one resource based on priority rules (e.g., based on the ordered list, based on UE ID, cell ID etc.), and if none of resources satisfy the condition, may skip the SRS transmission. The WTRU may transmit the SRS on the determined SRS resource(s) using the corresponding CLI-type specific transmission parameters, e.g., using CLI-type specific power control parameters.

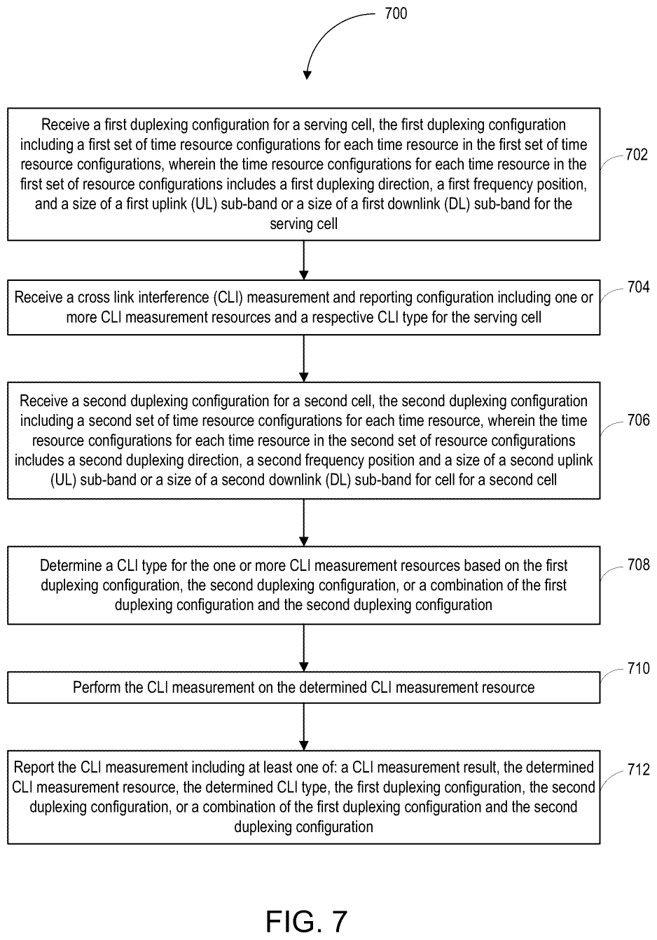

FIG. 7 is a flowchart of an example process of a WTRU determining CLI measurement resources based on a second cell SBFD configuration.

As shown in FIG. 7, process 700 may include receiving a first duplexing configuration for a serving cell, the first duplexing configuration including a first set of time resource configurations for each time resource in the first set of time resource configurations, where the time resource configurations for each time resource in the first set of resource configurations includes a first duplexing direction, a first frequency position, and a size of a first uplink (UL) sub-band or a size of a first downlink (DL) sub-band for the serving cell at 702. For example, a WTRU may receive a first duplexing configuration for a serving cell, the first duplexing configuration including a first set of time resource configurations for each time resource in the first set of time resource configurations, where the time resource configurations for each time resource in the first set of resource configurations includes a first duplexing direction, a first frequency position, and a size of a first uplink (ul) sub-band or a size of a first downlink (dl) sub-band for the serving cell, as described above. As also shown in FIG. 7, process 700 may include receiving a cross link interference (CLI) measurement and reporting configuration including one or more CLI measurement resources and a respective CLI type for the serving cell at 704. For example, a WTRU may receive a CLI measurement and reporting configuration including one or more CLI measurement resources and a respective CLI type for the serving cell, as described above. As further shown in FIG. 7, process 700 may include receiving a second duplexing configuration for a second cell, the second duplexing configuration including a second set of time resource configurations for each time resource, where the time resource configurations for each time resource in the second set of resource configurations includes a second duplexing direction, a second frequency position and a size of a second uplink (UL) sub-band or a size of a second downlink (DL) sub-band for cell for a second cell at 706. For example, a WTRU may receive a second duplexing configuration for a second cell, the second duplexing configuration including a second set of time resource configurations for each time resource, where the time resource configurations for each time resource in the second set of resource configurations includes a second duplexing direction, a second frequency position and a size of a second uplink (UL) sub-band or a size of a second downlink (DL) sub-band for cell for a second cell, as described above. As also shown in FIG. 7, process 700 may include determining a CLI type for the one or more CLI measurement resources based on the first duplexing configuration, the second duplexing configuration, or a combination of the first duplexing configuration and the second duplexing configuration at 708. For example, a WTRU may determine a CLI type for the one or more cli measurement resources based on the first duplexing configuration, the second duplexing configuration, or a combination of the first duplexing configuration and the second duplexing configuration, as described above. As further shown in FIG. 7, process 700 may include performing the CLI measurement on the determined CLI measurement resource at 710. For example, a WTRU may perform the CLI measurement on the determined CLI measurement resource, as described above. As also shown in FIG. 7, process 700 may include reporting the CLI measurement including at least one of: a CLI measurement result, the determined CLI measurement resource, the determined CLI type, the first duplexing configuration, the second duplexing configuration, or a combination of the first duplexing configuration and the second duplexing configuration at 712. For example, a WTRU may report the CLI measurement including at least one of: a CLI measurement result, the determined CLI measurement resource, the determined CLI type, the first duplexing configuration, the second duplexing configuration, or a combination of the first duplexing configuration and the second duplexing configuration, as described above.

Process 700 may include additional implementations, such as any single implementation or any combination of implementations described below and/or in connection with one or more other processes described elsewhere herein. In a first implementation, each time resource corresponds to a slot, a symbol, or a combination of a slot and a symbol.

In a second implementation, alone or in combination with the first implementation, duplexing includes a sub-band full duplex (SBFD) operation mode, and where the first duplexing direction is a first SBFD pattern and the second duplexing direction is a second SBFD pattern. In a third implementation, alone or in combination with the first and second implementation, the CLI type includes at least one of a co-channel CLI type, a SBFD leakage CLI type, or an inter-carrier CLI leakage type.

In a fourth implementation, alone or in combination with one or more of the first through third implementations, the second duplexing configuration for the second cell is received in a medium access control (MAC) message, a radio resource control (RRC) message, or a downlink control information (DCI) message and includes a second cell identity (cell ID). In a fifth implementation, alone or in combination with one or more of the first through fourth implementations, determining the CLI type for measurement resource for performing CLI measurement further may include: determining there are no CLI measurement resources of the determined CLI type and a same respective CLI type included in the received CLI measurement and reporting configuration.

In a sixth implementation, alone or in combination with one or more of the first through fifth implementations, performing the CLI measurement on the determined CLI measurement resource is skipped in a case where there are no CLI measurement resources of the determined CLI type and a same respective CLI type included in the received CLI measurement and reporting configuration. A seventh implementation, alone or in combination with one or more of the first through sixth implementations, process 700 may include sending an indication that the CLI measurement is skipped in the case where there are no CLI measurement resources of the determined CLI type and a same respective CLI type included in the received CLI measurement and reporting configuration, and reporting layer 3 (L3 ) measurements. In an eighth implementation, alone or in combination with one or more of the first through seventh implementations, further includes determining a CLI measurement resource for performing the CLI measurement based on priority rules in a case where it is determined there are more than one CLI measurement resource of the determined CLI resource type and the same respective CLI resource type.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed in a wireless/transmit receive device, the method comprising:
receiving a first duplexing configuration for a serving cell, the first duplexing configuration including a first set of time resource configurations for each time resource in the first set of time resource configurations, wherein the time resource configurations for each time resource in the first set of resource configurations includes a first duplexing direction, a first frequency position, and a size of a first uplink (UL) sub-band or a size of a first downlink (DL) sub-band for the serving cell;
receiving a cross link interference (CLI) measurement and reporting configuration including one or more CLI measurement resources and a respective CLI type for the serving cell;
receiving a second duplexing configuration for a second cell, the second duplexing configuration including a second set of time resource configurations for each time resource, wherein the time resource configurations for each time resource in the second set of resource configurations includes a second duplexing direction, a second frequency position and a size of a second uplink (UL) sub-band or a size of a second downlink (DL) sub-band for cell for a second cell;
determining a CLI type for the one or more CLI measurement resources based on the first duplexing configuration, the second duplexing configuration, or a combination of the first duplexing configuration and the second duplexing configuration;
determining a CLI measurement resource for performing a CLI measurement based on the determined CLI type and a corresponding respective CLI type included in the CLI measurement and reporting configuration;
performing the CLI measurement on the determined CLI measurement resource; and
reporting the CLI measurement including at least one of: a CLI measurement result, the determined CLI measurement resource, the determined CLI type, the first duplexing configuration, the second duplexing configuration, or a combination of the first duplexing configuration and the second duplexing configuration.

2. The method of claim 1, wherein each time resource corresponds to a slot, a symbol, or a combination of a slot and a symbol.

3. The method of claim 2, wherein duplexing includes a sub-band full duplex (SBFD) operation mode, and wherein the first duplexing direction is a first SBFD pattern and the second duplexing direction is a second SBFD pattern.

4. The method of claim 3, wherein the CLI type includes at least one of: a co-channel CLI type, a SBFD leakage CLI type, or an inter-carrier CLI leakage type.

5. The method of claim 4, wherein the second duplexing configuration for the second cell is received in a medium access control (MAC) message, a radio resource control (RRC) message, or a downlink control information (DCI) message and includes a second cell identity (cell ID).

6. The method of claim 5, wherein determining the CLI type for measurement resource for performing CLI measurement further comprises: determining there are no CLI measurement resources of the determined CLI type and a same respective CLI type included in the received CLI measurement and reporting configuration.

7. The method of claim 6, wherein performing the CLI measurement on the determined CLI measurement resource is skipped in a case where there are no CLI measurement resources of the determined CLI type and a same respective CLI type included in the received CLI measurement and reporting configuration.

8. The method of claim 7, further comprising sending an indication that the CLI measurement is skipped in the case where there are no CLI measurement resources of the determined CLI type and a same respective CLI type included in the received CLI measurement and reporting configuration, and reporting layer 3 (L3) measurements.

9. The method of claim 4, further comprising: determining a CLI measurement resource for performing the CLI measurement based on priority rules in a case where it is determined there are more than one CLI measurement resource of the determined CLI resource type and a same respective CLI resource type.

10. A wireless/transmit receive unit (WTRU) comprising:
processor circuitry; and
a transceiver communicatively coupled to the processor circuitry and configured to:
receiving a first duplexing configuration for a serving cell, the first duplexing configuration including a first set of time resource configurations for each time resource in the first set of time resource configurations, wherein the time resource configurations for each time resource in the first set of resource configurations includes a first duplexing direction, a first frequency position, and a size of a first uplink (UL) sub-band or a size of a first downlink (DL) sub-band for the serving cell;
receive a cross link interference (CLI) measurement and reporting configuration including one or more CLI measurement resources and a respective CLI type for the serving cell; and
receive a second duplexing configuration for a second cell, the second duplexing configuration including a second set of time resource configurations for each time resource, wherein the time resource configurations for each time resource in the second set of resource configurations includes a second duplexing direction, a second frequency position and a size of a second uplink (UL) sub-band or a size of a second downlink (DL) sub-band for cell for a second cell;
the processor circuitry configured to:
determine a CLI type for the one or more CLI measurement resources based on the first duplexing configuration, the second duplexing configuration, or a combination of the first duplexing configuration and the second duplexing configuration;
determine a CLI measurement resource for performing a CLI measurement based on the determined CLI type and a corresponding respective CLI type included in the CLI measurement and reporting configuration; and
perform the CLI measurement on the determined CLI measurement resource; and
the transceiver configured to:
report the CLI measurement including at least one of: a CLI measurement result, the determined CLI measurement resource, the determined CLI type, the first duplexing configuration, the second duplexing configuration, or a combination of the first duplexing configuration and the second duplexing configuration.

11. The WTRU of claim 10, wherein each time resource corresponds to a slot, a symbol, or a combination of a slot and a symbol.

12. The WTRU of claim 11, wherein duplexing includes a sub-band full duplex (SBFD) operation mode, and wherein the first duplexing direction is a first SBFD pattern and the second duplexing direction is a second SBFD pattern.

13. The WTRU of claim 12, wherein the CLI type includes at least one of: a co-channel CLI type, a SBFD leakage CLI type, or an inter-carrier CLI leakage type.

14. The WTRU of claim 13, wherein the transceiver is further configured to receive the second duplexing configuration for the second cell in a medium access control (MAC) message, a radio resource control (RRC) message, or a downlink control information (DCI) message and includes a second cell identity (cell ID).

15. The WTRU of claim 14, wherein the processor circuitry is further configured to determine there are no CLI measurement resources of the determined CLI type and a same respective CLI type included in the received CLI measurement and reporting configuration.

16. The WTRU of claim 15, wherein the processor circuitry is further configured to skip performing the CLI measurement in a case where the processor circuitry determines there are no CLI measurement resources of the determined CLI type and a same respective CLI type included in the received CLI measurement and reporting configuration.

17. The WTRU of claim 16, wherein the transceiver is further configured to send an indication that the CLI measurement is skipped in the case where there are no CLI measurement resources of the determined CLI type and a same respective CLI type included in the received CLI measurement and reporting configuration, and reporting layer 3 (L3 ) measurements.

18. The WTRU of claim 13, wherein the processor circuitry is further configured to: determine a CLI measurement resource for performing the CLI measurement based on priority rules in a case where it is determined there are more than one CLI measurement resource of the determined CLI resource type and a same respective CLI resource type.
